(19) United States
(12) Patent Application Publication
(10) Pub. No.: US 2026/0329903 A1
(43) Pub. Date: Oct. 22, 2026

(54) SYSTEM

(71) Applicant: SoftBank Group Corp., Tokyo (JP)

(72) Inventor: Ryuichi MAE, Tokyo (JP)

(73) Assignee: SoftBank Group Corp., Tokyo (JP)

(21) Appl. No.: 19/650,363

(22) Filed: Apr. 17, 2026

(30) Foreign Application Priority Data
Apr. 22, 2025 (JP) 2025-070216

(51) Int. Cl. G06F 16/3329; G06F 16/31; G06F 16/3332; G06F 16/338; G06F 40/58; G10L 15/26

(52) U.S. Cl. CPC G06F 16/33295; G06F 16/31; G06F 16/3338; G06F 16/338; G06F 40/58; G10L 15/26

(57) ABSTRACT

The present invention relates to a system for centrally searching, acquiring, and providing information distributed and accumulated across a plurality of internal company information management platforms, and is characterized by receiving a question in a natural language from a user, semantically searching only information according to a user authority by a text embedding technology, and automatically generating and presenting an optimal answer sentence using a generative AI. Furthermore, the system includes a self-maintenance function for automatically collecting, integrating, and updating information, access control according to a security level, personalization, multilingual support, and the like, thereby simultaneously realizing efficiency improvement of information search, speeding up of business, prevention of information management from becoming dependent on individual skills, and security securing.

### CROSS-REFERENCE TO RELATED APPLICATION

The present application claims priority to and incorporates by reference the entire contents of Japanese Patent Application No. 2025-070216 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is that a huge amount of information distributed and accumulated across a plurality of information management platforms such as an internal company portal, a document management system, and a knowledge base in a company must be individually searched when an employee needs it, and because the location of the information and the search method are complicated, a great deal of time and effort is required for information search, resulting in a decrease in business efficiency, a delay in decision-making, and an increase in employee stress and frustration. In addition, because information is distributed across a plurality of sites and systems, updating and maintenance of information become dependent on individual skills, variations occur in answer content and accuracy for each automatic response system such as a bot, and there is also a maintenance problem that an answer desired by a user and an actual answer greatly deviate from each other due to incomplete updating or obsolescence of information. Furthermore, since confidentiality and viewing authority differ for each piece of information, it is difficult to perform appropriate information access control according to a security level, and there is an inherent risk of information leakage and a danger of inappropriate information provision. In addition, in conventional keyword searches and simple FAQ-type automatic responses, there is a problem that a user's question intention and context cannot be sufficiently understood, and necessary information cannot be reached rapidly and accurately.

Therefore, an object of the present invention is to simultaneously solve a plurality of problems such as efficiency improvement of information search, speeding up of business, prevention of information management from becoming dependent on individual skills, security securing, and employee satisfaction improvement by utilizing advanced technologies such as natural language processing, generative AI, machine learning, and text embedding, cross-sectionally and comprehensively searching a plurality of internal company information sources, accurately understanding a user's question intention, providing optimal information according to a security level in real time, and further enabling automatic updating and self-evolution of information.

### SUMMARY OF THE INVENTION

Means for solving the problems according to the present invention configures a system for centrally searching, acquiring, and providing internal company information distributed and accumulated across a plurality of information management platforms, the system comprising: an input unit configured to receive a question in a natural language from a user; a search unit configured to extract only accessible information by referring to authority information of the user based on the question, semantically compare the extracted information and the question sentence using a text embedding technology, and select information with the highest relevance; an output unit configured to generate an answer sentence in a natural language using a generative AI with the selected information and the question sentence as inputs, and present the answer sentence to the user; and a self-maintenance unit configured to automatically detect an update or a new addition of the internal company information and reflect the update or the new addition in an information source database, wherein at least a part of processing of the search unit and the output unit is executed by the generative AI, whereby the user can acquire optimal information according to an authority in real time only by a question in a natural language without individually searching a plurality of information sources, and automatic updating and self-evolution of information are realized, thereby simultaneously achieving efficiency improvement of information search, speeding up of business, prevention of information management from becoming dependent on individual skills, and security securing.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

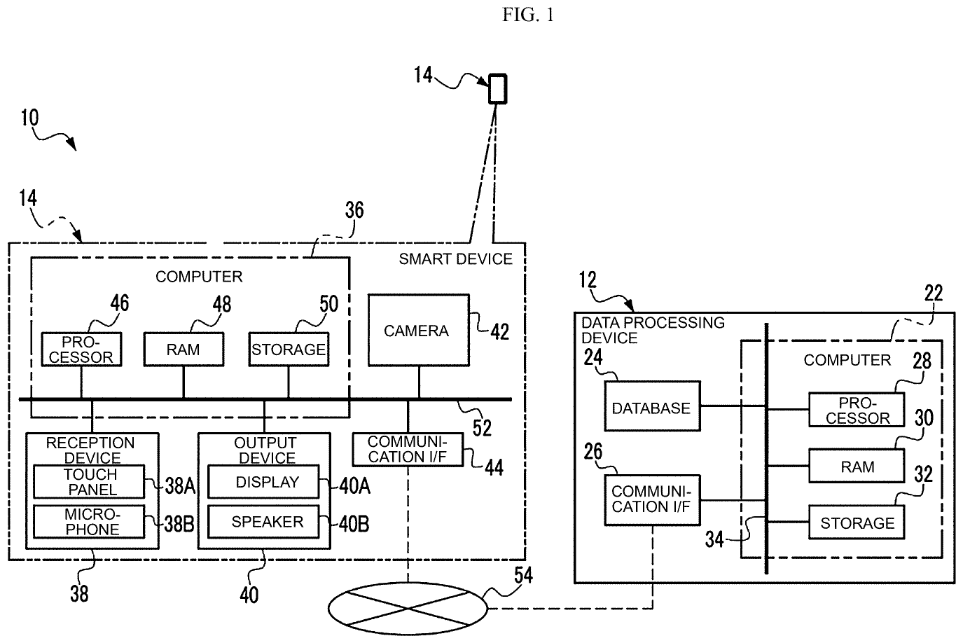

FIG. 1 Shows an Example Configuration of a Data Processing System 10 According to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

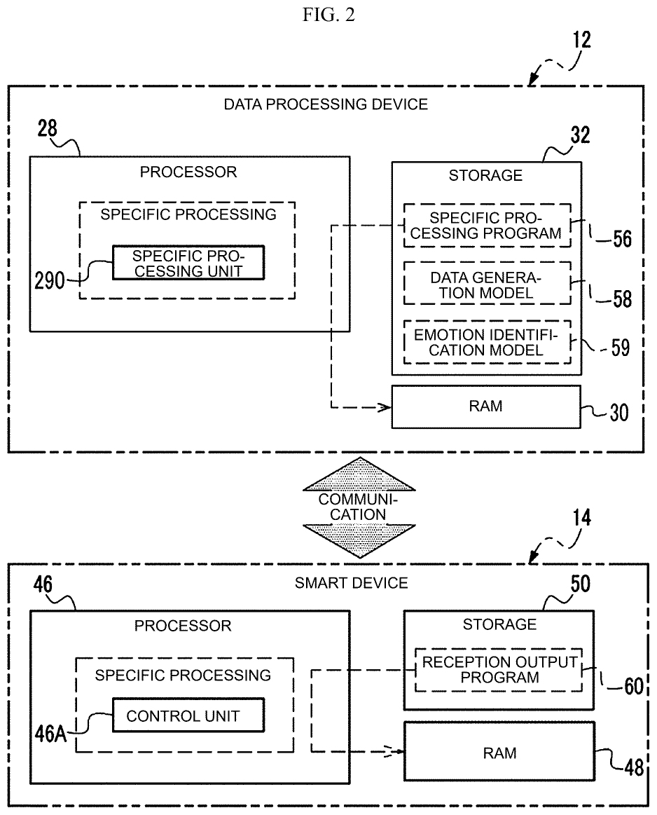

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail.

The system of the present invention is composed of a server and a terminal, the server is installed in a cloud environment or an on-premises environment, and the terminal is composed of various devices such as a personal computer, a smartphone, a tablet, and a wearable device. A user interface unit is implemented on the terminal side, and a user inputs a question in a natural language through a chatbot-format screen, a voice input interface, a form input screen, or the like. For example, various usage forms are assumed, such as opening a chat window on a web browser of a personal computer and inputting “Tell me how to settle expenses”, voice-inputting “I want to know about the new welfare system” on a dedicated application of a smartphone, or inputting “Tell me the application flow for remote work” into a form on an internal company portal application of a tablet. On the terminal side, as an input assistance function, suggestion of a past question history, automatic completion during input, text conversion of a voice recognition result, automatic correction of typographical errors, display of a question template, and the like can also be implemented. Specifically, the present system is composed of a server group including a central processing unit and a main storage device, and a plurality of terminal devices connected via a communication network. The present server group is constructed on a parallel computing cluster using a virtualization technology. The present terminal device is hardware including an input device and a display. The present user interface unit functions as a client application executed on a processor of the terminal device. The present user interface unit acquires a keystroke or a voice signal from the user in real time. The present user interface unit transmits the acquired input data to the server using an asynchronous communication protocol. The present system implements a lightweight recurrent neural network on the terminal side as the input assistance function. The present neural network receives a time-series character vector of a past input history as an input. The present neural network outputs a probability distribution of a word appearing next. The present system draws a word candidate with the highest probability on the screen based on this probability distribution. The present processing unit executes an acoustic feature amount extraction process for a voice input. The present processing unit inputs the extracted mel-frequency cepstral coefficients to a voice recognition model. The present voice recognition model receives a time-series tensor of the acoustic feature amount as an input. The present voice recognition model outputs a corresponding text character string. The present system technically improves a conventional interface depending on human manual input by these non-conventional processing methods. The present system reduces input errors and suppresses invalid query transmission to the server. As a result, the present system exhibits a technical effect of reducing consumption of a communication band and improving processing efficiency of the entire system. The present technology dramatically reduces an input load of the user in use cases such as internal company help desk operations and customer support counters.

When the user inputs a question from the terminal, the question data is transmitted to the server together with additional information such as a user ID, an affiliated department, a job title, used terminal information, and a time stamp. On the server side, first, an authentication/authorization unit confirms the identity and authority of the user. For example, multi-layered authentication means such as single sign-on authentication, two-factor authentication, terminal authentication, and IP address restriction can be combined. After the authentication, an accessible information range is dynamically determined by referring to authority information of the user (for example, a general employee, a manager, an executive, a specific project member, etc.). For example, fine access control is possible such that management materials and personnel information are accessible only to executives, technical specifications are accessible only to a technical department, and company-wide notices are accessible to all employees. Specifically, a communication interface unit of the present server receives a packet transmitted from the terminal. The present packet includes a question text and various metadata as an encrypted payload. The present authentication/authorization unit decrypts the received packet and extracts a user identifier and a session token. The present authentication/authorization unit collates the extracted token with a session management table on a memory. The present system detects data falsification by cryptographic verification using a hash function. The present authentication/authorization unit executes a one-time password generation and verification algorithm in a multi-factor authentication process. When the authentication is successful, the present system loads a role-based access control list of the user from a database to the main storage device. The present access control list holds a read authority for each information resource in a bit mask format. The present system executes a logical AND operation of this bit mask and a security attribute of the information resource. The present system determines access availability at an extremely high speed by this hardware-level bit operation. The present system eliminates a conventional process in which a human administrator manually confirms an authority. The present system executes dynamic access control in milliseconds. The present system immediately blocks an access request to unauthorized data at a network layer or an application layer. The present system exhibits a technical effect of reducing a risk of information leakage and realizing secure data management. The present technology enables strict information control in use cases such as highly confidential research and development data and internal company systems of financial institutions handling personal information.

Next, a search unit operates and refers to an information database in which information is cross-sectionally collected and integrated from all internal company information sources such as an internal company portal, a document management system, a knowledge base, an FAQ system, an electronic bulletin board, an internal company SNS, a business manual, training materials, an email archive, a project management tool, a workflow system, a file server, a video sharing system, and a voice recording system. For example, business procedure manuals such as an “expense settlement manual”, a “business trip application procedure manual”, and a “purchasing application guide” are stored in the document management system, internal company rules such as a “remote work regulation”, a “security policy”, and an “information system usage regulation” are stored in the knowledge base, and frequently asked questions such as a “password reissue method”, an “internal company Wi-Fi connection method”, and a “welfare application method” are stored in the FAQ system. Detailed metadata such as a title, a text, a creator, an update date and time, a security level, an information type, a related tag, a reference URL, an attached file, a related image, a related video, language information, and a version number is added to each piece of information. Specifically, the present search unit issues a query to the information database constructed on a distributed file system. The present information collection and integration unit includes a crawler module periodically executed as a background process. The present crawler module calls an application programming interface provided by each system in the company. The present crawler module applies a natural language processing pipeline to the acquired unstructured data. The present processing unit extracts text from image data using an optical character recognition algorithm. The present processing unit removes noise from the extracted text data and executes a normalization process. The present processing unit executes morphological analysis and syntactic analysis on the normalized text data. The present processing unit extracts a keyword and an important expression from an analysis result and adds them as metadata. The present system indexes these metadata in a key-value data store. The present system monitors an update time stamp of each document, extracts only difference data, and updates the database. The present system significantly reduces calculation resources and a network band required for database synchronization by this difference update mechanism. The present system converts data of heterogeneous formats into structured data having a unified schema. The present system minimizes an overhead of disk input/output in a subsequent search process by this optimization of the data structure. The present system exhibits a technical effect of reducing latency of information search and realizing high-speed access to a large-scale data set. The present technology eliminates information silos in use cases such as a knowledge management system of a large enterprise possessing millions of documents.

The search unit extracts only accessible information based on the authority information of the user, converts the extracted information and the question sentence of the user into numerical vectors using a text embedding technology (for example, a BERT-based model, sentence transformer, word2vec, doc2vec, fastText, etc.), and calculates a semantic similarity. For example, in response to a question “Tell me the application method for remote work”, a plurality of pieces of related information such as a “remote work regulation”, a “work-from-home application procedure”, and a “telework guideline” are extracted. Furthermore, the most relevant information is ranked by also taking into consideration the freshness of information (update date and time), the number of references, past user evaluations, an information reliability score, and the like. For example, when a plurality of pieces of information having the same content exist, the latest version or highly evaluated information is preferentially selected. Specifically, the present search unit divides the question sentence of the user into subword units by a tokenizer. The present search unit inputs the divided token string to a text embedding neural network based on a large language model. The present neural network has a transformer architecture including a self-attention mechanism. Input data to the present neural network is a one-dimensional array of token IDs such as “remote work”, “of”, “application”, and “method”, for example. The present neural network outputs a high-dimensional floating-point number vector capturing a contextual meaning of the input token string. The present output data is, for example, a 768-dimensional dense vector, and each element takes a continuous value in a range of minus 1.0 to 1.0. The present search unit expands a document vector calculated in advance for each document in the information database on a memory. The present search unit calculates a cosine similarity between the question vector and each document vector by a parallel matrix operation. The present system speeds up this matrix operation using a tensor core of a graphics processing unit. The present search unit multiplies the calculated similarity score by a weighting coefficient based on the update date and time and the number of references. The present search unit calculates a final ranking score and sorts the documents in descending order of the score. Unlike a conventional search method depending on simple keyword matching, the present system adopts a non-conventional processing method of geometric distance calculation in a high-dimensional vector space. The present system exhibits a technical effect of absorbing orthographical variants and differences in synonyms and extracting information matching the true intention of the user with high accuracy. The present technology dramatically reduces search omissions in use cases such as a document search system of a legal department or a patent department where technical terms are frequently used.

A part of this semantic similarity calculation and information extraction processing is executed by an API of a generative AI or a generative AI model on the server. For example, the generative AI plays a role of simultaneously inputting the question sentence and the content of each piece of information and automatically selecting the most relevant information. When a plurality of pieces of candidate information exist, the generative AI can also summarize and integrate them to generate an optimal information set. For example, in response to a question “I want to know about the new welfare system”, an outline of the new system, an application method, a target person, notes, and the like are extracted from a plurality of information sources, and an integrated explanatory text is automatically generated. Specifically, the present system drives a generative artificial intelligence model to further scrutinize the extracted plurality of candidate documents. The present generative artificial intelligence model is a deep learning network having billions of parameters. The present processing unit combines the question sentence of the user and the text data of the extracted candidate documents to generate one input prompt tensor. Input data to the present generative artificial intelligence model is a two-dimensional tensor in which a token string of the question sentence and token strings of the plurality of documents are separated by a special token. The present generative artificial intelligence model executes a multi-layer self-attention operation on the input tensor. The present generative artificial intelligence model outputs a relevance probability score indicating to what extent each candidate document includes a direct answer to the question. The present output data is, for example, a normalized numerical value in a range of 0.0 to 1.0. The present processing unit selects only a document whose probability score exceeds a predetermined threshold as a final information set. The present generative artificial intelligence model extracts an important sentence from the selected plurality of documents and outputs a token string of a summary text integrating them. In this summarization process, the present system uses a language generation algorithm pre-trained using a cross-entropy error function. The present system replaces a mental process in which a human reads a plurality of documents, understands the contents, and summarizes them with a computer-specific processing method of tensor operation and probabilistic generation. The present system exhibits a technical effect of reducing a cognitive load of the user due to information overload and shortening a time to reach necessary information. The present technology dramatically improves business efficiency in use cases such as guidance on complex internal company procedures requiring reference to a plurality of regulations and manuals.

A generative AI cooperation unit generates a prompt to a generative AI (for example, a large language model) with the selected information and the question sentence of the user as inputs, and causes the generative AI to generate an answer sentence in a natural Japanese language. For example, in response to a question “Tell me the procedure for expense settlement”, a specific answer sentence such as “Expense settlement is applied from the expense system, and attachment of a receipt is essential. For detailed procedures, please refer to the expense settlement manual of the document management system.” is generated. The generative AI is not a mere excerpt of information, but understands the intention and context of the question, integrates and summarizes information obtained from a plurality of information sources, and creates an answer in a form easy for the user to understand. For example, in response to a question “I want to know about the new welfare system”, an outline of the new system, an application method, a target person, notes, and the like are extracted from a plurality of information sources, and an integrated explanatory text is automatically generated. Specifically, the present generative artificial intelligence cooperation unit dynamically constructs a system prompt based on the selected information set and the question sentence of the user. The present system prompt includes a control instruction defining a tone, a format, and a constraint condition of the answer. The present generative artificial intelligence cooperation unit inputs the constructed prompt to the large language model. Input data to the present large language model is a one-dimensional array having a length of several thousand tokens including context information, the question sentence, and the control instruction. The present large language model executes an autoregressive decoding process. The present large language model sequentially predicts and outputs a token having the highest probability of appearing next. The present output data is a text string of the answer sentence composed of a natural language. In the generation process, the present system adjusts hyperparameters such as a temperature parameter and top-P sampling to control a balance between diversity and accuracy of the output. The present system applies a post-processing filter to the generated answer sentence and automatically verifies whether an inappropriate expression or content violating an internal company policy is included. The present system generates a direct and contextual answer to the question of the user, rather than a mere list display of search results. The present system improves interaction between the user and the computer to be more intuitive and efficient by this advanced natural language generation technology. The present system exhibits a technical effect of reducing the number of trials and errors for the user to search for information and reducing a processing load of the entire system. The present technology significantly improves a self-resolution rate in use cases such as onboarding support for new employees and operation guidance for complex business systems.

Furthermore, the generative AI can also generate a personalized answer sentence in consideration of a past question history, an access tendency, and attribute information (for example, department, job title, work location, etc.) of the user. For example, even for the same question “application method for remote work”, an application flow for a sales department can be automatically guided to an employee of the sales department, and a procedure for a technical department can be automatically guided to an employee of the technical department. For example, an answer in a local language or a procedure based on a local rule can be automatically generated for an employee at an overseas base. Specifically, the present generative artificial intelligence cooperation unit acquires the attribute information of the user from a user profile database. The present processing unit encodes the acquired attribute information (department code, job title level, work location ID, etc.) as a categorical variable. The present processing unit inputs the encoded variable to an embedding layer to generate a user attribute vector. The present generative artificial intelligence cooperation unit combines this user attribute vector with a vector representation of the question sentence. Input data to the present large language model includes a multidimensional vector representing background information of the user in addition to the question sentence and the context information. The present large language model dynamically adjusts an attention weight based on this combined input representation. The present large language model outputs an answer text optimized for the attribute of the user. The present output data is a text string including, for example, a URL of a specific application system for the sales department and a URL of another system for the technical department. The present system inputs a past access history of the user as time-series data to a recurrent neural network to predict a current region of interest of the user. The present system adds this prediction result to the context of the prompt. The present system breaks away from a conventional method of uniform information provision and executes a non-conventional processing method of matching a user profile and information content in a multidimensional space. The present system exhibits a technical effect of filtering information irrelevant to the user and improving a precision ratio of information. The present technology realizes accurate information transmission in use cases such as guidance on employment regulations for each region in a multinational enterprise and presentation of different security guidelines for each job type.

An output unit returns the answer sentence generated by the generative AI to the user interface on the terminal side, and presents it to the user through a chatbot screen or a notification function. For example, in addition to displaying the answer sentence on the chatbot screen, a link to a related manual or FAQ can be automatically attached as necessary. Furthermore, a link to a related image, video, chart, or reference material can be automatically inserted into the answer sentence. For example, in response to a question “Tell me how to use the new attendance management system”, a video link of an operation procedure or a screenshot of an operation screen can be automatically attached. Specifically, the present output unit receives the text string of the generated answer sentence. The present output unit analyzes a specific keyword or pattern in the text string using a regular expression. The present output unit acquires a uniform resource locator of related multimedia content from the information database based on an analysis result. The present output unit dynamically generates a document object model tree of a hypertext markup language. The present output unit arranges a text node, an image tag, and an anchor tag in the generated document object model tree. The present output unit transmits the constructed rendering data to the terminal device via an asynchronous communication protocol. A browser engine of the present terminal device analyzes the received data and draws a graphical user interface on the screen. The present system executes a formatting process of dividing the text into appropriate paragraphs according to the length of the answer sentence to improve readability. When a video link is included, the present system automatically generates a thumbnail image of the video and incorporates a component for inline display. The present system supports a cognitive process of the user by adding visual information compared to text-only output. The present system provides a route through which the user can directly access a necessary operation procedure or reference material without performing an additional search. The present system exhibits a technical effect of reducing the number of operation steps of the user and shortening a time until task completion. The present technology promotes intuitive understanding in use cases such as operation training at the time of introducing a new software tool and troubleshooting of equipment.

A self-maintenance unit has a function of automatically detecting generation of new information or an update of existing information in each internal information management platform. For example, when a new manual is added to the document management system or when a regulation in the knowledge base is revised, the change is automatically detected and reflected in the information database. Specifically, a change is detected using an API, an RSS feed, a file monitoring function, or the like of the information management platform, content of the change is extracted as a semantic feature amount by a text embedding technology, and the information database is updated after automatically determining duplication or contradiction with the existing information. These processes can also utilize the generative AI to execute, for example, difference summarization of old and new information, automatic classification, tagging, deduplication, and the like with high accuracy. For example, when a plurality of manuals having the same content exist, the generative AI can compare the contents, automatically select the latest and most comprehensive one, and archive old information. Specifically, the present self-maintenance unit periodically executes a polling process on a data store of each information management platform. The present self-maintenance unit calculates a hash value of each document and compares it with a hash value saved at the time of a previous scan. When detecting a mismatch of the hash values, the present system determines that the document has been updated. The present processing unit acquires old and new versions of the updated document and applies a difference extraction algorithm. The present processing unit inputs the extracted difference text to the generative artificial intelligence model. Input data to the present generative artificial intelligence model is character string data including a deleted text block and an added text block. The present generative artificial intelligence model analyzes an intention and an influence range of the change and outputs a difference summary text. The present output data is a structured summary sentence such as “The upper limit of expenses in Chapter 3 has been changed from 50,000 yen to 100,000 yen”, for example. The present self-maintenance unit inputs the entire updated document to the text embedding model again to generate a new document vector. The present self-maintenance unit overwrites and updates a vector index in the information database with this new vector. The present system specifies a document group close in a vector space using a clustering algorithm, and calculates a duplication degree score. When the duplication degree score exceeds a threshold, the present system adds a deprecation flag to an old document. The present system eliminates a manual database update work by a human administrator and realizes autonomous data quality management. The present system guarantees that always latest and accurate information is a search target, and exhibits a technical effect of preventing erroneous business execution based on old information. The present technology dramatically reduces a management cost in use cases such as document management of a compliance department where regulations are frequently revised.

The security management unit strictly manages a security level and a viewing authority set for each piece of information, and prevents unauthorized information access by collating them with the authority information of the user. For example, management materials and personnel information limited to executives are excluded from search targets from general employees, and an information leakage risk is minimized by recording an access log. Furthermore, it is also possible to monitor an information viewing history and a download history in real time, and automatically notify an administrator when a suspicious access is detected. Specifically, the security management unit includes a packet sniffer module configured to monitor all data packets flowing in the system. The security management unit acquires an internet protocol address of a request source, a device identifier, and a request time for each access request of the user. The security management unit drives an access determination engine with the context information and the authority information of the user as inputs. The access determination engine evaluates a security policy rule set cached on a memory at high speed. The system implements an autoencoder-type neural network for anomaly detection. Input data to the neural network is a multidimensional behavioral feature amount vector having elements such as a past access frequency, an access time zone, and a download data amount of the user. The neural network executes processing of compressing an input vector into a low-dimensional space and then restoring the input vector to an original dimension. The neural network outputs a reconstruction error between the input vector and the restored vector as an anomaly score. The output data is a continuous value taking a range from 0 to infinity. When the anomaly score exceeds a dynamically set threshold value, the system detects the access as a suspicious behavior. Simultaneously with the detection, the system forcibly terminates a session of the user and transmits an alert event to a dashboard of the administrator. The system combines not only static rule-based defense but also an unconventional processing method of dynamic behavior detection using machine learning. The system exerts a technical effect of exhibiting high defense power even against a zero-day attack due to internal fraud or account hijacking. The technology constructs a robust security environment in a use case such as an integrated threat management system for protecting personal information of a customer or a trade secret of a company.

The log management unit records all question/answer histories, information access histories, information update histories, and the like in chronological order to ensure transparency and traceability of system operation. For example, it is possible to analyze at what timing and by whom specific information was referred to, what kind of questions are frequent, which information is frequently updated, and the like, and utilize the analysis for system improvement and information quality improvement. For example, it is also possible to automatically extract frequently asked questions and automatically generate and update them as an FAQ. Specifically, the log management unit collects all events occurring in the system via an asynchronous messaging queue. The log management unit writes the collected event data into a time-series database. The event data includes a user identifier, an input question text, a generated answer text, an identifier of a searched document, a latency taken for processing, and a feedback score from the user. The processing unit periodically executes batch processing on the accumulated log data. The processing unit applies a clustering algorithm such as a K-means method to a vector representation of the question text. The processing unit specifies a cluster having a high density in a high-dimensional vector space. The system extracts a question text closest to a center vector of the specified cluster as a representative question. The system inputs the representative question and an optimal answer thereto into a generative artificial intelligence model, and automatically generates a general-purpose FAQ entry. Input data to the generative artificial intelligence model is a list of pairs of a plurality of similar question histories and answers returned by the system. The generative artificial intelligence model integrates these and outputs text data in a concise Q&A format. The system automatically adds the generated FAQ entry to the information database and updates a search index. The system generates a statistical dashboard for quantitatively visualizing a usage status of the system. The system autonomously expands a knowledge base of the system itself using a data mining method, not limited to mere accumulation of log data. The system exerts a technical effect of reducing a calculation cost of answer generation for frequently asked questions and improving response performance of the entire system. The technology maximizes operational efficiency in a use case of knowledge management in which a support page is automatically enriched from a response history of customer support.

Furthermore, for example, even when there are different information systems for each department, such as a knowledge base for a sales department, technical documents for a technical department, and a collection of regulations for an administrative department, the generative AI can determine a semantic relevance between a question sentence and information content with high accuracy, and extract and integrate optimal information. For example, even for the same question “procedure for business trip application”, if the procedure is different between the sales department and the technical department, it is possible to refer to the affiliated department information of the user and automatically guide the procedure for the corresponding department. Further, for example, when information is managed in a plurality of languages, it is possible to realize multilingual support by the generative AI and automatically translate and generate an answer sentence according to a language setting of the user. For example, it is possible to automatically generate an answer with the same content in Japanese when a question is asked in Japanese, and in English when a question is asked in English. Specifically, the system executes routing processing of dynamically switching a partition of a database to be searched based on the affiliated department information of the user. The processing unit acquires a priority language setting from a profile of the user. The system executes a lightweight language identification classifier for determining a language of the input question sentence. The classifier receives an N-gram feature amount of characters as an input, and outputs a probability distribution of each language. When the language of the question sentence and a language of a document in the information database are different, the system drives a machine translation model. The machine translation model is a transformer-based neural network having an encoder-decoder structure. Input data to the machine translation model is a token sequence of a source language. The machine translation model outputs a token sequence of a target language. The system executes a vector search using the translated question sentence, and extracts a related document. The system inputs content of the extracted document into the machine translation model again, and translates the content into the priority language of the user. The generative AI cooperation unit generates an answer sentence in the language of the user using the translated context information. The system can also adopt a cross-lingual embedding model that directly performs semantic mapping between multiple languages on a high-dimensional vector space. The system executes complex processing of information search and provision across language barriers as real-time pipeline processing. The system exerts a technical effect of hiding a translation process inside the system and providing a seamless multilingual information access environment to the user. The technology is extremely useful in a use case such as an internal communication platform in which local employees in each country can immediately refer to information transmitted from a head office in their native languages in a global company having bases all over the world.

Further, for example, when the user asks a question “Tell me about internal company events this week”, the generative AI can cooperate with a calendar system or an event management system, automatically extract event information scheduled to be held this week, and collectively answer a date and time, a place, a participation target, an application method, and the like. For example, in response to a question “I want to know the latest internal company news”, it is possible to automatically extract the latest news article from an internal company portal or an electronic bulletin board, and summarize and present the article. For example, in response to a question “Tell me about training materials for new employees”, it is possible to extract corresponding materials from a training material management system, and automatically generate and guide a download link and an outline of the materials. Specifically, the system executes a named entity extraction model for extracting a specific intention from the question sentence of the user. The named entity extraction model is an algorithm based on a conditional random field or a bidirectional recurrent neural network. Input data to the model is a word token sequence of the question sentence. The model outputs an entity label such as “date”, “event”, or “system name” for each token. The system dynamically generates a calling parameter of an application programming interface for cooperating with an external system based on the extracted entity. The processing unit transmits a request to a calendar server or a news distribution server via a hypertext transfer protocol using the generated parameter. The processing unit receives structured data in a JSON format from the external system. The generative AI cooperation unit converts the received structured data into a natural language context, and incorporates the context into a prompt. The generative artificial intelligence model receives the prompt as an input, and outputs a comprehensive answer text to the question of the user. The system executes a processing method of integrating not only a static document search but also dynamically changing transaction data and real-time information. The system aggregates information distributed in a plurality of independent systems into one interface. The system exerts a technical effect of saving the user the trouble of switching a plurality of applications to search for information and improving the speed of business execution. The technology dramatically increases productivity in a use case of a digital assistant that centrally performs schedule confirmation, facility reservation, acquisition of the latest news, and the like with an interactive interface.

As described above, the embodiment of the present invention dramatically improves an information access experience of an employee and simultaneously realizes efficiency of information management and security assurance by placing the generative AI at the core and automating and optimizing all processes of information search, acquisition, provision, update, and management while clarifying role sharing between the server and the terminal. The generative AI plays an indispensable role in many of core processes of the system, such as semantic understanding of question content, relevance determination of information, automatic generation of an answer sentence, automatic summarization, classification, and tagging of information, personalization, and difference extraction at the time of information update. For example, advanced processing such as automatic generation of an FAQ, summarization of a manual, integrated answer of a plurality of information sources, answer optimization according to a user attribute, automatic classification and tagging of information, and obsolescence detection of information can also be realized by utilizing the generative AI. Furthermore, in the future, a highly expandable system configuration such as a recommendation function of analyzing an action history and a business process of the user and proactively proposing necessary information before the user asks a question, cooperation with a business automation workflow, and API cooperation with an external cloud service or a system of another company can also be realized. Specifically, the system according to the present embodiment functions as an advanced information processing platform integrating a plurality of neural network models and a distributed processing architecture. The system includes an orchestration engine configured to optimally allocate hardware resources including a central processing unit, a main storage device, and a graphics processing unit. By combining natural language processing, vector calculation, and a machine learning algorithm, the system executes data processing at a speed and accuracy that surpass a human cognitive process while imitating the human cognitive process. The system has, as a core, an unconventional processing method of mapping input unstructured data to a high-dimensional vector space and evaluating a semantic relevance by mathematical distance calculation. In an inference process of the generative artificial intelligence model, the system executes billions of floating-point operations in parallel, and dynamically generates a natural language adapted to a context. The system simultaneously improves precision and recall of information search by these technical processes. The system reduces an operation and maintenance cost of the entire system by integrating automatic update of a database, dynamic control of an access authority, and an autonomous analysis function of log data. As a future expansion, the system can additionally implement a recommendation neural network module configured to receive an operation history tensor of the user as an input and predictively output an information vector required next. The system exerts a technical effect of improving information processing capability of computer technology itself and reducing latency of information access in a large-scale and complex data environment to the utmost limit. The technology is applicable to use cases in all industrial fields as a core knowledge management platform for promoting digital transformation of a company.

### System Configuration

The system according to the present embodiment includes a user interface unit, an authentication/authorization unit, an information collection and integration unit, a search unit, a generative AI cooperation unit, an output unit, a self-maintenance unit, a security management unit, and a log management unit.

The user interface unit operates on various terminals such as a personal computer, a smartphone, a tablet, and a wearable device, and receives a question input in a natural language from a user through a chatbot-format screen, a voice input interface, a form input screen, or the like. For example, it corresponds to various usage forms such as a case of inputting “Tell me the method of expense settlement” on a web browser of a personal computer, a case of voice-inputting “I want to know about a new welfare system” with a dedicated application of a smartphone, and a case of inputting “Tell me the application flow for remote work” into a form with an internal company portal application of a tablet. Further, as an input assistance function, suggestion of a past question history, automatic completion in the middle of input, text conversion of a voice recognition result, automatic correction of a typographical error or omission, display of a question template, and the like are realized to assist the user to efficiently and accurately input a question. Specifically, the user interface unit is implemented as a native application running on an operating system of each terminal device or a script engine in a web browser. The user interface unit makes an event listener process configured to monitor an input event from the user resident. The processing unit transmits a partial input character string to a server using an asynchronous communication protocol for each keystroke. An input prediction module on the server side inputs the received partial character string into a character-level recurrent neural network. Input data to the neural network is time-series data of a one-hot vector representation of characters in the middle of input. The neural network outputs a probability distribution of a word or a phrase highly likely to be input next. The user interface unit draws a prediction candidate list returned from the server as a drop-down menu on a screen in real time. In the voice input interface, the processing unit converts an analog voice waveform acquired from a microphone into a digital signal, and applies a noise canceling filter. The processing unit inputs the preprocessed voice data into a voice recognition engine, and converts the voice data into a text string. The system cooperatively executes these input assistance processes in a distributed computing environment on a client side and a server side. The system reduces the number of physical input operations of the user, and prevents an invalid processing request due to an input error. As a result, the system exerts a technical effect of optimizing network traffic and improving responsiveness of the entire system. The technology provides extremely high operability in a use case such as voice query input through a wearable device for a field worker who has difficulty in keyboard input.

When the user accesses the system, the authentication/authorization unit confirms identity using multi-layered authentication means such as single sign-on authentication, two-factor authentication, terminal authentication, and IP address restriction, and acquires additional information such as a user ID, an affiliated department, a job title, used terminal information, and a time stamp. For example, it determines an authority level such as a general employee, a manager, an executive, or a specific project member, and dynamically determines an accessible information range. Furthermore, it finely controls an access authority according to the affiliated department or the job title of the user, and realizes fine-grained access control, for example, making management materials and personnel information accessible only to executives, technical specifications accessible only to a technical department, and company-wide notices accessible to all employees. Specifically, the authentication/authorization unit establishes an encrypted communication channel with the terminal device using a secure socket layer or a transport layer security protocol. The authentication/authorization unit receives credential information transmitted from the user, and executes one-way encryption using a hash function. The processing unit collates the encrypted hash value with a registered value in an authentication database. When two-factor authentication is requested, the system executes a time-based one-time password generation algorithm, and transmits a verification code to a mobile device of the user. The authentication/authorization unit issues a session token in a JSON Web Token format to the user whose authentication is successful. A user identifier, an issue time, an expiration date, and a role-based authority claim are embedded in the token together with a digital signature. The system verifies the signature of the token by a public key cryptosystem in all subsequent application programming interface requests. The authentication/authorization unit collates the authority claim extracted from the token with an access matrix on a memory, and determines whether or not access to a requested resource is permitted. The system omits an authority inquiry to the database each time, and executes a stateless authentication/authorization process. The system dramatically reduces overhead of authentication processing by this unconventional token-based processing method. The system exerts a technical effect of realizing a strict zero-trust security model while suppressing an authentication delay to a millisecond order even under a simultaneous access environment of tens of thousands of people. The technology ensures safe and high-speed system utilization in a use case such as a telework environment in which remote access from an external network is normalized.

The information collection and integration unit cross-sectionally collects information from all internal company information sources such as an internal company portal, a document management system, a knowledge base, an FAQ system, an electronic bulletin board, an internal company SNS, a business manual, training materials, an email archive, a project management tool, a workflow system, a file server, a video sharing system, and a voice recording system, and constructs an integrated information database. For example, business procedure manuals such as “expense settlement manual”, “business trip application procedure manual”, and “purchasing application guide” are stored in the document management system, internal company rules such as “remote work regulations”, “security policy”, and “information system usage regulations” are stored in the knowledge base, and frequently asked questions such as “password reissue method”, “internal company Wi-Fi connection method”, and “welfare application method” are stored in the FAQ system. Detailed metadata such as a title, a text, a creator, an update date and time, a security level, an information type, a related tag, a reference URL, an attached file, a related image, a related video, language information, and a version number is added to each piece of information. The information collection and integration unit automatically collects information by various means such as API cooperation, file monitoring, periodic crawling, and Webhook reception, and performs preprocessing such as deduplication, format unification, tagging, language determination, and version management. Specifically, the information collection and integration unit includes a data integration engine configured to control an extract, transform, load (ETL) pipeline. The data integration engine executes a plurality of connector modules corresponding to a protocol of each information source (for example, a file transfer protocol, a hypertext transfer protocol, a database connection protocol, etc.) in parallel. The processing unit executes format conversion processing on the collected raw data, and extracts plain text data. For a portable document format or an image file, the processing unit drives an optical character recognition engine to detect a text area, and converts the text area into a character code. The processing unit applies a natural language processing library to the extracted text data, and executes preprocessing of stop word removal, stemming, and lemmatization. The information collection and integration unit calculates a latent topic distribution from the preprocessed text data using a topic modeling algorithm (for example, latent Dirichlet allocation). The system automatically adds an optimal related tag to each document based on the calculated topic distribution. The system identifies a language of the text using a language determination model, and records a language code as metadata. The system stores the data and the metadata normalized through these processes in a distributed NoSQL database. The system converts heterogeneous unstructured data into base data of a unified tensor representation processable by a machine learning model. The system exerts a technical effect of maximizing inference accuracy of subsequent search processing and the generative artificial intelligence model by automating the preprocessing of data. The technology significantly reduces a cost of data cleansing in a use case of digital transformation of a company that digitizes a huge amount of legacy documents over the past decades and constructs a company-wide cross-sectional search platform.

The search unit extracts only accessible information from an information database held by an information collection and integration unit based on authority information of a user, converts the extracted information and a question sentence of the user into numerical vectors using a text embedding technology, and calculates a semantic similarity. For example, in response to a question “Tell me the application method for remote work”, a plurality of pieces of related information such as “remote work regulations”, “telecommuting application procedures”, and “telework guidelines” are extracted. Furthermore, the most highly relevant information is ranked by also taking into account the newness of the information (update date and time), the number of references, past user evaluations, the reliability score of the information, and the like. For example, when a plurality of pieces of information having the same content exist, the latest version or highly evaluated information is preferentially selected. The search unit utilizes various text embedding models such as a BERT-based model, sentence transformer, word2vec, doc2vec, and fastText to improve semantic search accuracy. Specifically, the search unit includes a search engine module that executes an approximate nearest neighbor search algorithm on the database constructed by the information collection and integration unit. Upon receiving the question sentence of the user, the search unit inputs it into the text embedding model. Input data to the text embedding model is a fixed-length integer array obtained by tokenizing the question sentence and performing a padding process. The text embedding model has an architecture in which a plurality of encoder layers of a transformer are stacked, and outputs a dense vector considering a context from the input array. The output data is, for example, an array of floating-point numbers having 384 or 768 dimensions. Using this question vector as a query, the search unit executes a similarity calculation on a group of millions of document vectors stored in a vector database. In order to avoid the calculation cost of a full search, the system executes a neighborhood search in a high-dimensional space in logarithmic time using an index structure such as a hierarchical navigable small world graph. The search unit applies a decay function or a boost function based on metadata (update date and time, reliability score, etc.) to the calculated cosine similarity score, and recalculates a final ranking score. The system overcomes the limitations of a conventional inverted index search that relies on exact keyword matches, and adopts a non-conventional processing method of a vector space search based on semantic relevance. The system exhibits a technical effect of extracting contextually most appropriate information at high speed and with high accuracy even for an ambiguous question from the user. The present technology dramatically improves the recall rate of information retrieval in use cases such as an electronic medical record search system of a medical institution and a precedent search system of a law firm where synonyms and abbreviations of technical terms are frequently used.

A generative AI cooperation unit generates a prompt to a generative AI with the information selected by the search unit and the question sentence of the user as inputs, and causes the generative AI to generate an answer sentence in natural Japanese. For example, in response to a question “Tell me the procedure for expense settlement”, a specific answer sentence such as “Expense settlement is applied for from the expense system, and attachment of a receipt is mandatory. For detailed procedures, please refer to the expense settlement manual in the document management system.” is generated. The generative AI cooperation unit understands the intent and context of the question, rather than merely extracting information, integrates and summarizes information obtained from a plurality of information sources, and creates an answer in a form easy for the user to understand. For example, in response to a question “I want to know about the new welfare system”, an overview of the new system, an application method, target persons, notes, and the like are extracted from a plurality of information sources, and an integrated explanatory sentence is automatically generated. The generative AI cooperation unit can also generate a personalized answer sentence in consideration of a past question history, an access tendency, and attribute information (for example, department, job title, work location, etc.) of the user. For example, even for the same question “application method for remote work”, an application flow for the sales department can be automatically guided to an employee in the sales department, and a procedure for the engineering department can be automatically guided to an employee in the engineering department. Specific examples of the prompt sentence to be read by the generative AI include “User's question: ‘Tell me the procedure for expense settlement’, Reference information: ‘Expense settlement is applied for from the expense system, and attachment of a receipt is mandatory. For detailed procedures, please refer to the expense settlement manual in the document management system.’, Based on this information, please answer clearly and concisely.” and “User's question: ‘I want to know about the new welfare system’, Reference information: ‘A new welfare system will be introduced from fiscal 2024, and employees can apply for health checkup subsidies, telecommuting allowances, childcare support funds, and the like. For the application method, please refer to the welfare page of the internal company portal.’, Based on this information, please answer in detail and clearly.” Specifically, the generative AI cooperation unit divides the question sentence of the user and the text data of the search result by a tokenizer. The processing unit converts each divided token into, for example, a 1024-dimensional token embedding vector. The processing unit adds position encoding information to these vectors to construct an input tensor. The system inputs this input tensor into a large language model. The model adopts a Transformer architecture equipped with a self-attention mechanism. The model analyzes the input context and calculates a probability distribution of a token that appears next. The output from the model is a probability distribution vector of a vocabulary size dimension. As a specific example, the model outputs an appearance probability score for each token such as “expense”, “settlement”, and “is”. The processing unit selects a token sequence with the highest probability using a beam search algorithm. The processing unit detokenizes the selected token sequence and converts it into a natural language text stream. The processing unit transfers the generated text stream to a subsequent output unit. Through this series of processing, the system completely replaces the work of a human reading and summarizing a plurality of documents. The system exhibits a technical effect of efficiently utilizing computer resources and generating a highly accurate answer in milliseconds. A specific application field of the present technology includes a fully automated system for internal company help desk operations in a large enterprise.

An output unit returns the answer sentence generated by the generative AI to a user interface on a terminal side, and presents it to the user through a chatbot screen or a notification function. For example, in addition to displaying the answer sentence on the chatbot screen, a link to a related manual or FAQ can be automatically attached as necessary. Furthermore, it is also possible to automatically insert a link to a related image, video, chart, or reference material into the answer sentence. For example, in response to a question “Tell me how to use the new attendance management system”, a video link of an operation procedure or a screenshot of an operation screen can be automatically attached. Specifically, the output unit stores the text data received from the generative AI cooperation unit in a JSON format payload. The output unit transmits the payload to the terminal via an HTTPS protocol. The output unit detects a specific keyword in the answer sentence using a regular expression or a named entity extraction model. The processing unit queries a metadata database using the detected keyword as a search key. The processing unit acquires a URL of a corresponding video or image binary data. The processing unit dynamically embeds the acquired multimedia data into the answer sentence as an HTML or Markdown format tag. The system exhibits a technical effect of providing visual information compared to a text-only answer and dramatically improving the user's level of understanding. In order to optimize a communication band, the system automatically compresses image data to a thumbnail size and transmits it. Specific application fields of the present technology include an operation support system for complex software and a troubleshooting guide for mechanical equipment.

A self-maintenance unit has a function of automatically detecting generation of new information or an update of existing information in each internal information management platform. For example, when a new manual is added to the document management system or when a regulation in the knowledge base is revised, the change is automatically detected and reflected in the information database. Specifically, a change is detected using an API, an RSS feed, a file monitoring function, or the like of the information management platform, content of the change is extracted as a semantic feature amount by a text embedding technology, and the information database is updated after automatically determining duplication or contradiction with existing information. For example, when a plurality of manuals having the same content exist, the generative AI can compare the contents, automatically select the latest and most comprehensive one, and archive old information. Furthermore, automatic classification, tagging, summarization, deduplication, version management, information obsolescence detection, and the like of information are also automatically executed to maintain the freshness and quality of the information. Specifically, the self-maintenance unit executes API polling or Webhook event listening. The processing unit captures a file system change event in milliseconds. The processing unit extracts old and new document texts. The system inputs the extracted text into a pre-trained language model. The model converts the input text into a 768-dimensional document embedding vector. The processing unit calculates a cosine similarity between the old and new vectors. The output from the processing unit is a similarity score taking a continuous value from 0.0 to 1.0. As a specific example, the processing unit determines that the contents are duplicated if the score is 0.95 or more. When determining that there is duplication, the processing unit compares time stamps. The processing unit updates a flag of the old document to inactive. The processing unit excludes the old document from an index of the vector database. The system brings about a technical effect of preventing database bloat and reducing the number of floating-point operations during a search. The system maintains search accuracy over a long period of time. A specific application field of the present technology includes an automatic version management system for internal company regulations and manuals that are updated daily.

A security management unit strictly manages a security level and a viewing authority set for each piece of information, and collates them with the authority information of the user to prevent unauthorized information access. For example, management materials and personnel information limited to executives are excluded from search targets by general employees, and an access log is recorded to minimize an information leakage risk. Furthermore, it is also possible to monitor an information viewing history and a download history in real time, and automatically notify an administrator when suspicious access is detected. For example, a large amount of access in a short time by the same user, access in a time zone not normally used, or the like is detected, and an alert is issued. Specifically, the security management unit holds an access control list or a role-based access control matrix in an on-memory key-value store. The processing unit extracts an authority bitmask from a session token of the user. The processing unit executes a logical AND operation with a required authority bitmask of the document. The system applies an anomaly detection algorithm using AI. The system constructs a multidimensional numerical vector including an access frequency of the user, an access time zone, and geographical coordinates of an IP address, and inputs it into an AI model. The model adopts an unsupervised learning algorithm such as an autoencoder or an isolation forest. The output from the model is an anomaly score represented by a numerical value from 0.0 to 1.0. As a specific example, the model determines a case where the score exceeds 0.8 as an abnormal behavior. When detecting an anomaly, the processing unit forcibly disconnects the corresponding session. The processing unit transmits a warning event to a dashboard of the administrator via an asynchronous messaging queue. The system has a technical effect of blocking an unknown unauthorized access pattern that is difficult to detect on a rule basis in real time, and reducing the information leakage risk to the utmost limit. A specific application field of the present technology includes a protection system for a corporate network that handles highly confidential research and development data and personal information.

A log management unit records all question/answer histories, information access histories, information update histories, and the like in chronological order to ensure transparency and traceability of system operation. For example, it is possible to analyze at what timing and by whom specific information was referred to, what kind of questions are frequent, which information is frequently updated, and the like, and use them for system improvement and information quality improvement. For example, it is also possible to automatically extract frequently asked questions and automatically generate and update them as an FAQ. Furthermore, by analyzing a usage tendency and a business process of the user using log data, a highly expandable system configuration such as a recommendation function that proactively proposes necessary information before the user asks a question in the future, cooperation with a business automation workflow, and API cooperation with an external cloud service or another company's system can also be realized. Specifically, the log management unit serializes event data generated from each module in a JSON format. The processing unit transmits the serialized data to a distributed message streaming platform. The system persists the received data in a column-oriented database. The system periodically executes a log analysis process using AI. The system converts a set of search query character strings for the past 30 days into TF-IDF vectors, and inputs them into a clustering algorithm. The output from the algorithm is a cluster ID to which each query belongs and a center vector of the cluster. As a specific example, the algorithm extracts a topic cluster such as “password reset” or “paid leave application”. The processing unit extracts a representative query of a frequent cluster. The processing unit automatically registers the extracted query as a new entry in an FAQ database. The system brings about a technical effect of eliminating manual log analysis work by the administrator and constructing a self-optimization loop of the system. The system shortens a query response time of the database. A specific application field of the present technology includes an automatic knowledge expansion function of an operator support system in a large-scale call center.

In this way, the system according to the present embodiment operates in cooperation with each unit, realizes advanced information search, provision, and management functions with the generative AI at the core, dramatically improves the information access experience of employees, and simultaneously achieves efficiency of information management and security assurance. Specifically, the user interface unit, the authentication and authorization unit, the search unit, the generative AI cooperation unit, the output unit, the self-maintenance unit, the security management unit, and the log management unit constituting the system are containerized as independent microservices, respectively. The system dynamically scales the number of operating containers by an orchestration tool. The system distributively executes inference processing of a large language model on a parallel computing cluster using GPUs. The system suppresses the latency of the entire system to within several hundred milliseconds. The system exhibits a technical effect of realizing high availability and scalability capable of withstanding simultaneous access by tens of thousands of people. A specific application field of the present technology includes a company-wide integrated knowledge management platform in a multinational enterprise expanding globally.

### Implementation Steps

Step 1: User Question Reception A user inputs a question in a natural language using a chatbot screen, a voice input interface, a form input screen, or the like operating on a terminal such as a personal computer, a smartphone, or a tablet. For example, various usage forms are assumed, such as inputting “Tell me the method of expense settlement” on a web browser of a personal computer, voice-inputting “I want to know about the new welfare system” on a smartphone application, or inputting “Tell me the application flow for remote work” into a form on an internal company portal application of a tablet. On the terminal side, input assistance functions such as suggestion of a past question history, automatic completion during input, text conversion of a voice recognition result, automatic correction of typographical errors and omissions, and display of a question template are also implemented. Specifically, the application on the terminal side captures a keystroke event of the user or a voice stream from a microphone in real time. When voice input is selected, the processing unit converts the acquired voice waveform data into an acoustic feature amount vector such as a mel-frequency cepstrum coefficient. The system constructs a time-series tensor with a frame length of 25 milliseconds and a shift length of 10 milliseconds, and inputs it into a voice recognition AI model. The model adopts a recurrent neural network or a Transformer architecture. The output from the model is a probability distribution sequence of characters at each time step. As a specific example, the model outputs probabilities of a character sequence such as “a”, “ta”, “ra”, “shi”, and “i”. The processing unit decodes an optimal text character string using a beam search algorithm. The processing unit automatically inputs the decoded character string into an input field. The system exhibits a technical effect of overcoming restrictions of an input device such as a keyboard and significantly reducing the input load of the user. A specific application field of the present technology includes a hands-free manual search system at a factory site or a construction site.
Step 2: User Authentication and Authority Determination On the server side, additional information such as a user ID, an affiliated department, a job title, used terminal information, and a time stamp is received together with the question data transmitted from the user, and identity is confirmed using multi-layered authentication means such as single sign-on authentication, two-factor authentication, terminal authentication, and IP address restriction. After authentication, the authority information of the user is referred to, and an accessible information range is dynamically determined according to an authority level of, for example, a general employee, a manager, an executive, a specific project member, or the like. Specifically, the authentication and authorization unit on the server side extracts a JSON Web Token from a header of the received HTTP request. The processing unit verifies a signature of the token using a public key cryptography method, and confirms that there is no falsification of data. The processing unit extracts a unique identifier of the user from a payload of the token. The processing unit collates the identifier with an authority profile cached in an in-memory database. The processing unit expresses the authority level of the user as a bit flag. The processing unit executes a bitwise AND operation with an access control list assigned to each document. The processing unit dynamically narrows down an index partition of a document to be searched based on the calculation result. The system physically and logically reduces a search target space before executing a search query. The system brings about a technical effect of significantly reducing the calculation amount of search processing and improving response speed. A specific application field of the present technology includes a secure information search system maintaining an information partition between departments in a financial institution.
Step 3: Information Collection and Integration The information collection and integration unit cross-sectionally collects information from all internal company information sources such as an internal company portal, a document management system, a knowledge base, an FAQ system, an electronic bulletin board, an internal company SNS, a business manual, training materials, an email archive, a project management tool, a workflow system, a file server, a video sharing system, and a voice recording system, and constructs an integrated information database. For example, the information is automatically collected by various means such as API cooperation, file monitoring, periodic crawling, and Webhook reception, and preprocessing such as deduplication, format unification, tagging, language determination, and version management is performed. Specifically, the information collection and integration unit extracts unstructured data acquired from various data sources into plain text using an optical character recognition engine or an HTML parser. The processing unit divides the extracted text into fixed-length chunks of, for example, 512 tokens. The system inputs each text chunk into a pre-trained language model. An output from the model is a 768-dimensional high-dimensional dense vector. The processing unit indexes the generated vector together with metadata in a vector database. The database adopts a hierarchical navigable small world graph algorithm to speed up approximate nearest neighbor search. The system maps data of heterogeneous formats into a unified vector space. The system has a technical effect of enabling high-speed and semantic cross-sectional search independent of formats. A specific application field of the present technology includes construction of an integrated knowledge base of a plurality of systems at the time of corporate merger or acquisition.
Step 4: Semantic Search and Information Extraction The search unit extracts only accessible information from the information database held by the information collection and integration unit based on the authority information of the user, converts the extracted information and the question sentence of the user into numerical vectors using a text embedding technology (for example, a BERT-based model, sentence transformer, word2vec, doc2vec, fastText, etc.), and calculates a semantic similarity. For example, in response to a question “Tell me the application method for remote work”, a plurality of pieces of related information such as “remote work regulations”, “telecommuting application procedure”, and “telework guidelines” are extracted. The most relevant information is ranked by also taking into account the newness of the information, the number of references, user evaluation, a reliability score, and the like, and the latest version or highly evaluated information is preferentially selected. Specifically, the search unit processes the question sentence of the user with a tokenizer and inputs it to an encoder model to generate a question vector consisting of a 768-dimensional floating-point array. The processing unit calculates an inner product or a cosine similarity between the question vector and each document vector for the vector database. The system inputs the question vector and millions of document vectors into an AI model. An output from the model is a similarity score taking a continuous value from 0.0 to 1.0 for each document. As a specific example, the model outputs a value such as a score of 0.85 or 0.72. The processing unit performs weighted addition of a decay function based on an elapsed time of the document or an importance score based on a PageRank algorithm to the similarity score. The processing unit calculates a final ranking score and extracts the top five document texts. The system realizes a search based on context and semantic closeness, rather than simple keyword matching. The system exhibits a technical effect of completely preventing search omissions due to orthographical variants or synonyms. A specific application field of the present technology includes a search system for past cases in medical institutions or law firms where technical terms and abbreviations are frequently used.
Step 5: Answer Generation by Generative AI The generative AI cooperation unit generates a prompt to the generative AI with the information selected by the search unit and the question sentence of the user as inputs, and causes the generative AI to generate an answer sentence in natural Japanese. For example, specific examples of the prompt sentence include “User's question: ‘Tell me the procedure for expense settlement’, Reference information: 'Expense settlement is applied for from the expense system, and attachment of a receipt is mandatory. For detailed procedures, please refer to the expense settlement manual in the document management system.', Based on this information, please answer clearly and concisely.” and “User's question: ‘I want to know about the new welfare system’, Reference information: ‘A new welfare system has been introduced from fiscal year 2024, and employees can apply for health checkup subsidies, telecommuting allowances, childcare support funds, and the like. For the application method, please refer to the welfare page on the internal company portal.’, Based on this information, please answer in detail and clearly.” The generative AI understands the intent and context of the question, integrates and summarizes information obtained from a plurality of information sources, and creates an answer in a form easy for the user to understand. Specifically, the generative AI cooperation unit combines the extracted top document texts with a system prompt and the question sentence of the user. The processing unit constructs a single input prompt character string. The system tokenizes the constructed prompt character string and inputs it to a large language model as an integer array tensor having, for example, 2048 dimensions. The model is an autoregressive neural network having tens of billions to hundreds of billions of parameters. An output from the model is a probability distribution vector of a next succeeding token. As a specific example, the model sequentially outputs tokens such as “expense”, “is”, and “system”. The processing unit detokenizes the output token sequence and converts it into a text stream of a natural language. The processing unit asynchronously transmits the converted text to the output unit in units of chunks. The system dynamically generates a summary sentence that directly answers the user's question, rather than a simple enumeration of search results. The system exhibits a technical effect of reducing the cognitive load on the user and significantly shortening the information acquisition time. A specific application field of the present technology includes an automatic answer draft creation system for operators in customer support.
Step 6: Personalization and Multilingual Support The generative AI cooperation unit generates a personalized answer sentence in consideration of the past question history, access tendency, and attribute information (for example, department, job title, work location, etc.) of the user. For example, even for the same question “application method for remote work”, an application flow for the sales department can be automatically guided to an employee in the sales department, and a procedure for the technical department can be automatically guided to an employee in the technical department. In addition, when information is managed in a plurality of languages, it is also possible to realize multilingual support by the generative AI and automatically translate and generate an answer sentence according to the language setting of the user. Specifically, the generative AI cooperation unit acquires an affiliated department code, a job title level, and a preferred language code of the user from a user profile database. The processing unit inserts these pieces of attribute information as a meta-prompt at the beginning of the prompt. The system inputs a prompt tensor including the user attribute information into the AI model. An output from the model is a text token sequence according to the constraints of the specified attribute and language. As a specific example, the model outputs an English token sequence. The processing unit reconfirms the language of the generated text by a determination module. The processing unit triggers a regeneration loop when it does not match the specified language. The system dynamically generates various expressions optimized for the user's context from a single knowledge base. The system brings about a technical effect of reducing translation resources for multilingual support and maintenance costs of a plurality of manuals. A specific application field of the present technology includes a common help desk system for employees all over the world in a multinational corporation.
Step 7: Answer Presentation and Related Information Addition The output unit returns the answer sentence generated by the generative AI to the user interface on the terminal side, and presents it to the user through a chatbot screen or a notification function. For example, in addition to displaying the answer sentence on the chatbot screen, a link to a related manual or FAQ can be automatically attached as necessary. Furthermore, it is also possible to automatically insert a link to a related image, video, chart, or reference material in the answer sentence. Specifically, the output unit push-distributes the generated text stream to the terminal using Server-Sent Events or a WebSocket protocol. A rendering engine on the terminal side draws the received text on the screen in real time. The processing unit simultaneously receives metadata of the document that is the basis of the answer generation as a JSON array. The user interface unit dynamically decorates a specific entity in the text as a hyperlink. The processing unit binds a click event listener to the decorated element. The system has a technical effect of shortening the perceived waiting time of the user by visualizing the generation process of the answer in real time. The system ensures verifiability against factual errors in the answer by providing a direct access path to the information source. A specific application field of the present technology includes an immediate presentation system of drawings and video manuals in troubleshooting of complex mechanical equipment.
Step 8: Self-Maintenance and Automatic Information Update The self-maintenance unit automatically detects generation of new information or an update of existing information in each internal information management platform, and reflects it in the information database. For example, when a new manual is added to the document management system or when a regulation in the knowledge base is revised, the change is automatically detected and reflected in the information database. The generative AI is also utilized for automatic classification, tagging, summarization, deduplication, version management, information obsolescence detection, and the like of information. A specific example of the prompt sentence includes “Please compare the contents of the old and new manuals, summarize the differences, and determine whether there is any duplication or contradiction.” Specifically, a background daemon process of the self-maintenance unit periodically fetches an update log of each data source. The processing unit extracts the text of the document in which the update is detected, and inputs it into a vectorization pipeline. The system inputs text chunks of the old and new documents into a Transformer model fine-tuned for a natural language inference task. An output from the model is a probability distribution indicating a relationship between the two texts. As a specific example, the model outputs that the probability of a contradiction class is 0.85. The processing unit sets an alert flag on an administrator's dashboard when a contradiction is detected. The processing unit assigns a deprecated tag to the vector index of the old document. The system automatically detects and corrects obsolescence and contradictions in the knowledge base. The system exhibits a technical effect of preventing deterioration of search quality and significantly reducing maintenance man-hours of a system administrator. A specific application field of the present technology includes an automatic consistency check system for internal company regulations in a compliance department where legal revisions are frequently made.
Step 9: Security Management and Access Control The security management unit strictly manages a security level and a viewing authority set for each piece of information, and collates them with the authority information of the user to prevent unauthorized information access. For example, management materials and personnel information limited to executives are excluded from search targets by general employees, and an access log is recorded to minimize an information leakage risk. It is also possible to monitor a viewing history and a download history of information in real time, and automatically notify the administrator when suspicious access is detected. Specifically, the security management unit intercepts all search requests and document acquisition requests at an API gateway layer. The processing unit extracts an IP address, a user agent, and a session ID of a request source. The processing unit updates an in-memory rate limit counter. The system inputs a past access history sequence of the user into a sequence anomaly detection model using a recurrent neural network. An output from the model is a reconstruction error score indicating a degree of divergence between a predicted probability distribution of a next access behavior and an actual behavior. As a specific example, the model outputs a value in which the error score exceeds a threshold value of 0.9. The processing unit immediately invalidates the access authority of the session when the threshold value is exceeded. The processing unit dynamically adds an IP block rule to a firewall. The system detects and blocks abnormal data removal due to an internal crime or account hijacking in units of milliseconds. The system exhibits a technical effect of strongly protecting information assets. A specific application field of the present technology includes a data leakage prevention system in a call center that handles personal information and credit card information of customers.
Step 10: Log Management and Usage Tendency Analysis The log management unit records all question/answer histories, information access histories, information update histories, and the like in chronological order to ensure transparency and traceability of system operation. For example, it is possible to analyze at what timing and by whom specific information was referred to, what kind of questions are frequent, which information is frequently updated, and the like, and use them for system improvement and information quality improvement. By analyzing the usage tendency and business process of the user using the log data, it is also possible to realize a highly expandable system configuration in the future, such as a recommendation function that proactively proposes necessary information before the user asks a question, cooperation with a business automation workflow, and API cooperation with an external cloud service or another company's system. Specifically, the log management unit asynchronously buffers structured logs output from each microservice. The processing unit transfers the buffered data to a central data lake. The system executes batch processing on the log data on the data lake using a distributed processing framework. The system inputs a matrix of the search query history and clickstream data of the user into a recommendation model using deep learning. An output from the model is a recommendation score vector of unviewed documents for each user. As a specific example, the model outputs a score of 0.92 for document A and a score of 0.88 for document B. The processing unit push-distributes documents with high scores to the portal screen of the user as recommended articles. The system predicts potential information needs of the user. The system brings about a technical effect of dramatically improving business efficiency by providing necessary information before the user takes a search action. A specific application field of the present technology includes an automatic recommendation system for appropriate training materials according to learning progress in an onboarding process for new employees.

### Specific Use Case

For example, when an employee inputs “Tell me the application method for the new remote work system” in a natural language on a chatbot screen operating on a web browser of a personal computer, the user interface unit receives the question and transmits it to the server together with additional information such as a user ID, an affiliated department, a job title, used terminal information, and a time stamp. The authentication/authorization unit performs single sign-on authentication or terminal authentication, determines that the user is a general employee and belongs to the sales department, and dynamically determines an information range accessible by the employee in the sales department. The information collection and integration unit cross-sectionally collects related information such as “remote work regulations”, “telecommuting application procedure”, and “telework guidelines” from the internal company portal, the document management system, the knowledge base, the FAQ system, the electronic bulletin board, the internal company SNS, the business manual, the training materials, the workflow system, and the like, and extracts only information viewable by the employee in the sales department from the integrated information database. The search unit converts the question sentence of the user and the extracted information into numerical vectors by a text embedding technology, calculates a semantic similarity, and selects the most relevant information such as “remote work regulations (for sales department)” and “telecommuting application procedure exclusively for sales department”. The generative AI cooperation unit generates a prompt to the generative AI with the selected information and the question sentence of the user as inputs, and causes the generative AI to read a prompt sentence such as, for example, “User's question: ‘Tell me the application method for the new remote work system’, Reference information: ‘Employees in the sales department need to make a prior application from the remote work application page on the internal company portal and obtain approval from their superior. At the time of application, business content and a scheduled telecommuting date are described, and remote work becomes possible after approval. For details, refer to the remote work regulations in the knowledge base.’, Based on this information, please answer clearly and concisely for employees in the sales department.” The generative AI understands the intent and context of the question, integrates and summarizes information obtained from a plurality of information sources, and generates a specific answer sentence such as “In order for an employee in the sales department to use the new remote work system, it is necessary to make a prior application from the remote work application page on the internal company portal, describe business content and a scheduled telecommuting date, and obtain approval from a superior. For detailed procedures and notes, refer to the remote work regulations in the knowledge base.” The output unit returns the answer sentence generated by the generative AI to the chatbot screen, and automatically attaches a link to a related application page or regulation document. When the remote work regulations or the application procedure manual is updated, the self-maintenance unit automatically detects the change by API cooperation or a file monitoring function, and keeps the information database in the latest state. The security management unit provides only information viewable by the employee in the sales department, and excludes management materials limited to executives, application procedure manuals of other departments, and the like from search targets. The log management unit records the question/answer history, the information access history, and the information update history in chronological order, and utilizes them for future system improvement and information quality improvement. Furthermore, even for various questions such as “Tell me the contents of the new welfare system”, “I want to know the latest procedure for expense settlement”, “Tell me how to apply for an internal company event”, “I want you to guide me to training materials for the technical department”, and “I want you to answer in the local language for employees at overseas bases”, it is possible to extract optimal information according to the user attribute, authority, and question content in the same process, automatically generate a personalized answer sentence in a natural language using the generative AI, and present it with related materials and links added. Specific examples of the prompt sentence to be read by the generative AI include “User's question: ‘I want to know the latest procedure for expense settlement’, Reference information: ‘Expense settlement is applied for from the expense system, and attachment of a receipt is mandatory. A new application form has been introduced from April 2024, and input of a project code is required at the time of application. For details, refer to the expense settlement manual in the document management system.’, Based on this information, please answer clearly and concisely.” and “User's question: ‘I want you to guide the remote work application method in the local language for employees at overseas bases’, Reference information: ‘Employees at overseas bases need to apply for remote work from an application page supporting the local language and obtain approval from a local manager. For details, refer to the multilingual knowledge base.’, Based on this information, please answer clearly in the local language.” In these use cases, the system of the present invention realizes advanced semantic understanding and information integration, personalization, security control, and self-maintenance with the generative AI as a core, and can dramatically improve the information access experience of employees. Specifically, the system seamlessly executes an end-to-end pipeline from user input to vectorization, search, prompt construction, large language model inference, and output. The processing unit tokenizes the question text and converts it into a 768-dimensional vector. The processing unit executes an approximate nearest neighbor search algorithm in the vector database. The system inputs a prompt tensor combining the extracted text and the question into the large language model. An output from the model is a probability distribution of tokens constituting the answer text. The processing unit detokenizes the output tokens and streaming-distributes them to the user interface. The system immediately summarizes and translates complex internal company regulations and procedures according to the attributes of the user and provides them. The system has a technical effect of dramatically reducing the number of inquiries to back-office departments and improving company-wide productivity. A specific application field of the present technology includes a completely unmanned system of an internal company help desk regarding routine work such as human resources and general affairs in a large enterprise.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described more specifically and in detail. The system of the present invention is an AI chatbot-type information providing system that cross-sectionally and dynamically integrates and manages information assets of an entire city and generates and provides an optimal answer in real time to a question in a natural language in order to respond to diverse information needs of residents and administrative staff in a smart city. The system is composed of a server and a terminal, the server is installed in a cloud environment or an on-premises environment in a local government, and the terminal is composed of various devices such as a personal computer, a smartphone, a tablet, a kiosk terminal, a digital signage, a wearable device, and a voice assistant-equipped device. Specifically, a hardware configuration of the system adopts a topology that routes a request from a terminal device to an edge computing node or a central cloud server via a high-speed communication network. The server group is composed of a plurality of containerized microservice groups arranged behind a load balancer. The system independently scales each module such as an API gateway, an authentication service, a search service, and an inference service. The inference service operates on a parallel computing cluster using a GPU. The system executes a tensor operation of a large language model at high speed. The system processes simultaneous and multiple requests from millions of IoT devices and user terminals distributed throughout the city. The system brings about a technical effect of providing a scalable and highly available information processing infrastructure while minimizing a network delay. Specific application fields of the present technology include a smart city platform that integrally realizes improvement of resident services in a local government, real-time evacuation guidance in the event of a disaster, and business efficiency improvement of administrative staff.

A user interface unit is designed such that a resident or an administrative staff member can input a question in a natural language through a chatbot-format screen, a voice input interface, a form input screen, a touch panel operation, and further a reading function by voice synthesis, or the like. For example, various usage forms are assumed, such as a case where a resident inputs “Tell me the garbage collection days this week” on a smartphone application, a case where a voice input “Where is a nearby evacuation shelter?” is made on a digital signage terminal in front of a station, a case where an administrative staff member inputs “Search for the latest disaster prevention manual” on a dedicated screen of a personal computer, and a case where a foreign tourist inputs “I want to know the location of a tourist information center” on a multilingual touch panel. On the terminal side, as an input assistance function, suggestion of a past question history, automatic completion during input, text conversion of a voice recognition result, automatic correction of typographical errors and omissions, display of a question template, automatic presentation of an FAQ according to a user attribute, and further push-type information presentation based on an action history and position information of a user, and the like can be implemented. Specifically, the user interface unit acquires coordinate data of latitude and longitude acquired from a GPS sensor or a Wi-Fi positioning function of the terminal as a floating-point array. In the case of voice input, the processing unit Fourier-transforms PCM voice data acquired from a microphone and converts the PCM voice data into a spectrogram image tensor. The system inputs the spectrogram image tensor composed of a 128×128 two-dimensional array to a voice recognition model. The model adopts an architecture combining a convolutional neural network and a Transformer. An output from the model is a probability distribution of a text character string. As a specific example, the model outputs a character string “Where is a nearby evacuation shelter?”. The processing unit combines the recognized text and a position information vector, and transmits the combined text and position information vector to the server as a JSON payload. On the server side, a spatial search based on the position information is executed. The system provides an intuitive and multimodal input means even to an elderly person or a foreigner who is unfamiliar with keyboard operation, or a user in a panic state at the time of a disaster. The system exhibits a technical effect of dramatically improving information accessibility. Specific application fields of the present technology include a multilingual interactive AI concierge in a digital signage installed in a station or a public facility.

An authentication and authorization unit confirms identity using multi-layered authentication means such as a resident ID, a staff ID, a My Number, face authentication, two-factor authentication, terminal authentication, position information authentication, and further biometric authentication when a resident or an administrative staff member accesses the system, and acquires attribute information of a user (for example, residential area, age group, language setting, occupation, job title, affiliated department, used terminal information, time stamp, past usage history, etc.). For example, fine-grained access control is realized such that a resident is set to security level 1, an administrative staff member is set to security level 2, and a specific infrastructure administrator is set to security level 3, only public information is set as a search target for the resident, internal materials and procedure manuals are also set as search targets for the staff member, and advanced information such as an equipment inspection record and an emergency response manual is also provided to the infrastructure administrator. Specifically, when face authentication is selected, the authentication and authorization unit preprocesses an RGB image frame acquired from a camera of the terminal. The processing unit executes cropping, resizing, and normalization of a face region. The system inputs a normalized face image tensor composed of a 224×224×3 three-dimensional array to a face feature extraction model. The model adopts a deep convolutional neural network. An output from the model is a 512-dimensional face feature vector. The processing unit calculates a cosine similarity between the extracted feature vector and a feature vector of the user registered in advance in a database. As a specific example, the processing unit determines that the user is the person himself/herself when a similarity score exceeds a threshold value of 0.95. The processing unit issues a session token when identity verification is completed. The attribute information and a security clearance level of the user are encrypted and embedded in the token. The system completely eliminates a risk of forgetting or stealing a password. The system executes robust identity verification based on biometric information in milliseconds, and exhibits a technical effect of simultaneously improving a security level of the system and user convenience. Specific application fields of the present technology include a strict public personal authentication infrastructure combining a My Number card and face authentication in a core system of a local government.

An information collection and integration unit automatically collects information from all information management systems, websites, databases, electronic bulletin boards, FAQs, business manuals, IoT sensors, external cloud services, and the like in the city, such as garbage collection, disaster prevention, child-rearing support, transportation, administrative procedures, medical care, education, local events, energy, water and sewage, environment, tourism, local communities, infrastructure monitoring, IoT sensors, meteorological data, public facility reservation, resident opinion solicitation, evacuation guidance in the event of a disaster, local safety information, road construction information, power/gas supply status, water and sewage failure information, local shopping street information, public Wi-Fi spot information, local volunteer recruitment, school lunch information, library collection information, and local sports facility usage status, to construct an integrated database. For example, diverse information sources are targeted, such as a garbage collection schedule management system, a disaster prevention information portal, a child-rearing support portal, a bus operation information system, an administrative procedure online application system, a medical institution guidance system, a local event management system, an energy consumption monitoring system, a water and sewage management system, a tourist guidance system, real-time data from an IoT sensor, a Japan Meteorological Agency API, a public facility reservation system, a resident opinion solicitation form, an evacuation guidance application in the event of a disaster, a local safety information distribution system, a road construction information management system, a power/gas supply status monitor, a water and sewage failure information management system, a local shopping street information portal, a public Wi-Fi spot information management system, a local volunteer recruitment site, a school lunch information management system, a library collection management system, and a local sports facility usage status management system. Detailed metadata such as a title, a text, a creator, an update date and time, a security level, an information type, a related tag, a reference URL, an attached file, a related image, a related video, language information, a version number, a reliability score, an information source, a related area, a related event ID, an IoT sensor ID, a meteorological observation point ID, a facility ID, a failure occurrence time, an estimated recovery time, an event holding date and time, a participation application method, a usage fee, and an inquiry contact is added to each piece of information. The information collection and integration unit automatically collects information by various means such as API cooperation, file monitoring, periodic crawling, Webhook reception, IoT data stream reception, external cloud service cooperation, mail reception, CSV file automatic import, PDF document automatic analysis, bulletin board automatic reading by image recognition, and voice data automatic transcription, and performs preprocessing such as deduplication, format unification, tagging, language determination, version management, reliability evaluation, information freshness determination, automatic information classification, automatic information summarization, automatic information tagging, automatic information translation, and automatic information ranking. Specifically, the information collection and integration unit executes an advanced data pipeline for integrating unstructured data and structured data. The information collection and integration unit normalizes raw data acquired from each information source. The information collection and integration unit analyzes text data using a natural language processing model. The information collection and integration unit applies a convolutional neural network to image data. The information collection and integration unit executes an optical character recognition process for extracting text from an image. The information collection and integration unit applies a voice recognition process using a recurrent neural network to voice data. The information collection and integration unit converts a voice waveform into text data. The information collection and integration unit executes an automatic classification process using a large language model on the data that has undergone these preprocesses. In the automatic classification process, the information collection and integration unit generates a word embedding vector of text as input data. The word embedding vector is, for example, a 768-dimensional floating-point number array. The information collection and integration unit inputs the word embedding vector to a classifier. The classifier outputs a probability distribution tensor belonging to each category as output data. Specific examples of the probability distribution tensor include a numerical group such as 0.85 for a disaster prevention category, 0.10 for a transportation category, and 0.05 for an environment category. The information collection and integration unit determines a category indicating the highest probability as a main category of the information. The information collection and integration unit adds the determined category information as metadata. The information collection and integration unit executes a named entity extraction model for extracting an important keyword from the information. The named entity extraction model extracts entities such as a place name, a facility name, and a date and time from an input text sequence. The information collection and integration unit stores the extracted entities in the metadata as related tags. The information collection and integration unit executes a machine learning model for calculating a reliability score of the information. The machine learning model inputs domain reliability of an information source, an update frequency, a past access history, and the like as feature amounts. The machine learning model outputs a continuous value in a range of 0.0 to 1.0. The information collection and integration unit stores only information whose calculated reliability score exceeds a predetermined threshold value in the integrated database. Through these processes, the information collection and integration unit converts data in various formats into a format that can be mapped onto a unified vector space. The conversion process brings about a technical effect of dramatically improving accuracy of a high-dimensional vector search in a subsequent search unit. The technical effect is not merely automation of information organization by a human, but an improvement specific to computer technology, which is optimization of a data structure and execution efficiency improvement of a search algorithm inside a computer. Specific application fields of the information collection and integration unit include a data cooperation infrastructure of a city OS in a smart city, an integrated information portal system of a large-scale local government, and the like.

A search unit extracts only accessible information from an information database held by the information collection and integration unit based on authority information and attribute information of a user, converts the extracted information and a question sentence of the user into numerical vectors using a text embedding technology (for example, a BERT-based model, sentence transformer, word2vec, doc2vec, fastText, etc.), and calculates a semantic similarity. For example, in response to a question “Tell me the garbage collection days this week”, information such as “Burnable garbage is collected every Tuesday and Friday, and non-burnable garbage is collected on the second and fourth Wednesdays” is determined to have the highest relevance. Furthermore, the search unit ranks information with the highest relevance in consideration of freshness of information (update date and time), the number of references, a past user evaluation, a reliability score of information, reliability of an information source, regional suitability, real-time data from an IoT sensor, cooperation with meteorological data, proximity of an event holding date and time, an availability status of a facility, and the like, and preferentially selects a latest version or highly evaluated information. For example, when a plurality of pieces of information having the same content exist, the search unit automatically selects the latest and highly reliable information. The search unit can also use a combination of a plurality of text embedding models in order to improve semantic search accuracy. Furthermore, the search unit analyzes a past question history, an access tendency, a usage time zone, a used terminal, position information, an event participation history, a facility usage history, a resident attribute, business content of an administrative staff member, and the like of the user by machine learning, and also realizes personalized information recommendation and optimization of a search result. Specifically, the search unit executes a vector search algorithm for interpreting a question intention of the user with high accuracy. The search unit inputs the question sentence input from the user to a natural language processing module. The natural language processing module tokenizes the input character string. The natural language processing module inputs a token sequence to a text embedding model. The text embedding model is, for example, a multi-layer neural network based on a Transformer architecture. The text embedding model receives an integer array of up to 512 tokens as input data. The text embedding model outputs a high-dimensional vector expressing a semantic feature of the question sentence as output data. The high-dimensional vector is, for example, a 1024-dimensional dense vector. Specific examples of the high-dimensional vector include an array in which each element is composed of a floating-point number in a range of minus 1.0 to plus 1.0. The search unit expands a text vector of each piece of information stored in advance in the integrated database on a memory. The search unit calculates a cosine similarity between the vector of the question sentence and the vector of each piece of information. The search unit sorts the information in descending order based on the calculated similarity score. The search unit executes a weighting process based on metadata in addition to the similarity score. In the weighting process, the search unit applies an attenuation function that adds points as the update date and time of the information is newer. The search unit calculates a Euclidean distance between a current position of the user and position coordinates associated with the information. The search unit performs spatial weighting to increase the score as the distance is shorter. The search unit calculates a final ranking score by these complex score calculations. The search unit extracts top K pieces of information of the ranking score. The search unit transmits the extracted information to a subsequent generative AI cooperation unit. The search unit uses a past search history and a click log of the user as learning data. The search unit dynamically updates a weight parameter for score calculation using a learning-to-rank algorithm. The parameter update process is performed by minimizing a loss function using a gradient descent method. The vector operation and the dynamic weighting process in a high-dimensional space by the search unit absorb orthographical variants and synonyms that cannot be handled by a conventional keyword matching search. The process brings about a technical effect of dramatically reducing search omissions and improving an information reach rate. The technical effect is achieved by an unconventional procedure combining a specific rule-based process and an operation in a high-dimensional space. Specific application fields of the search unit include an FAQ search system for a local government that responds to an ambiguous inquiry from a resident, a past failure case search system for an infrastructure maintenance person in charge, and the like.

A generative AI cooperation unit generates a prompt to a generative AI (for example, a large language model) with the information selected by the search unit and the question sentence of the user as inputs, and causes the generative AI to generate an answer sentence in natural Japanese. For example, the generative AI cooperation unit generates a prompt sentence “Question from resident: ‘Tell me the garbage collection days this week’, Reference information: ‘Burnable garbage is collected every Tuesday and Friday, and non-burnable garbage is collected on the second and fourth Wednesdays’, Based on this information, please answer clearly and concisely for residents.”, and causes the generative AI to read the prompt sentence. The generative AI understands an intention and a context of the question, integrates and summarizes information obtained from a plurality of information sources, and creates an answer in a form easy for the user to understand, rather than merely extracting information. For example, in response to a question “Where is a nearby evacuation shelter?”, the generative AI can specify a nearest evacuation shelter based on the position information of the user, and integrally guide an address, an opening status, map information, a barrier-free support status, a capacity, whether pets are allowed, a congestion status of the evacuation shelter, facility information of the evacuation shelter (e.g., generator, Wi-Fi, toilet, nursing room, wheelchair support), an opening time of the evacuation shelter, an inquiry contact of the evacuation shelter, and the like. The generative AI cooperation unit can also generate a personalized answer sentence in consideration of a past question history, an access tendency, and attribute information (for example, residential area, age group, language setting, occupation, etc.) of the user. For example, even for the same question “I want to know the content of the child-rearing support system”, the generative AI cooperation unit can automatically guide a nursery school usage subsidy and a childcare consultation counter to a family with an infant, an after-school childcare and an education support fund to a family with a school-age child, and multilingual guidance to a foreign resident. In addition, when information is managed in a plurality of languages, the generative AI cooperation unit can realize multilingual support by the generative AI, and automatically translate and generate an answer sentence according to the language setting of the user. For example, when a foreign resident asks a question “Where is the nearest evacuation shelter?” in English, the generative AI cooperation unit can guide an address, a map, and an opening status of a nearest evacuation shelter in English, and also present a link to a multilingual evacuation shelter guidance page. Furthermore, the generative AI can also generate an advanced answer that supports business efficiency improvement and rapid decision-making, such as a summary of legal revision information and a business manual, an emergency response procedure, a summary of an equipment inspection record, and automatic generation of an instruction document in the event of a disaster, for an administrative staff member. Specifically, the generative AI cooperation unit executes an inference process for integrating a plurality of extracted pieces of fragmentary information and generating a natural language conforming to a context. The generative AI cooperation unit combines top K pieces of related information text received from the search unit, the question sentence of the user, and the attribute information of the user. The generative AI cooperation unit inserts the combined data into a predetermined template to construct a prompt character string. The generative AI cooperation unit inputs the constructed prompt character string to a large language model. The large language model is an autoregressive Transformer model having tens of billions to hundreds of billions of parameters. Input data to the large language model is a one-dimensional array of tokenized integer IDs. Specific examples of the input data include an array in which a token sequence representing a question sentence, a delimiter token, a token sequence representing reference information, and a system prompt token sequence instructing an output format are concatenated. The large language model analyzes a context of the input token sequence by a self-attention mechanism. The large language model sequentially predicts a token having the highest probability of appearing next. Output data from the large language model is a token ID array of generated text and a generation probability distribution tensor of each token. Specific examples of the output data include an ID sequence of words constituting an answer sentence and a numerical array of 0.0 to 1.0 indicating a certainty factor of each word. The generative AI cooperation unit converts the output token ID array into a natural language character string by a decoder. The generative AI cooperation unit applies a post-processing filter to the generated character string. The post-processing filter executes exclusion of an inappropriate term and a masking process of personal information. The generative AI cooperation unit determines that there is a possibility of hallucination when many tokens having a generation probability less than a predetermined threshold value are included. When there is a possibility of hallucination, the generative AI cooperation unit lowers a temperature parameter of the prompt and executes re-inference. The generative AI cooperation unit transmits a finally determined answer text to a subsequent output unit. The dynamic prompt construction and the autoregressive generation process by the generative AI cooperation unit provide information perfectly adapted to an individual situation of the user, unlike presentation of a static FAQ. The process brings about a technical effect of eliminating a cognitive load for the user to integrate a plurality of pieces of information by himself/herself and improving immediacy of information acquisition. The technical effect is a functional improvement of a computer system by incorporating an inference capability of a neural network into a specific business process. Specific application fields of the generative AI cooperation unit include a tourist guidance chatbot requiring multilingual support, a guidance assistant for an administrative procedure involving a complex conditional branch, and the like.

An output unit returns the answer sentence generated by the generative AI to a user interface on the terminal side, and presents the answer sentence to the user by various means such as a chatbot screen, a notification function, an email, an SMS, a push notification, a digital signage display, reading by voice synthesis, and smart speaker cooperation. For example, in addition to displaying the answer sentence on the chatbot screen, the output unit can also automatically insert a link to a related web page, an application form, map information, and a related material, an image, a video, a chart, and a link to a reference material as necessary. For example, in response to a question “Tell me the operation status of the bus”, the output unit can integrally present a current operation status, delay information, a timetable of a nearest bus stop, a map of an operation route, an estimated operation resumption, a link to a bus location system, an inquiry contact to a bus company, and the like. For example, in response to a question “I want to know the holding schedule of a local event”, the output unit can simultaneously guide an event name, a holding date and time, a holding place, a participation application method, a participation fee, organizer information, a past holding record, information on a related local shopping street, a link to an official website of the event, a link to an SNS account of the event, a map of an event venue, a congestion forecast of the event, a weather response policy of the event, and the like. Specifically, the output unit executes a rendering process for converting the generated text data into a multimodal format optimized for the used terminal of the user. The output unit receives an answer text and related metadata from the generative AI cooperation unit. The output unit generates a structured data object for display based on the received data. The structured data object is described in, for example, a JSON format. The output unit detects a place name and a facility name included in the answer text using a regular expression or a named entity extraction model. The output unit acquires geospatial coordinates corresponding to the detected entity from a map database. The output unit generates a script for dynamic map drawing using the acquired coordinate information. The output unit inputs the answer text to a voice synthesis engine. The voice synthesis engine is composed of an acoustic model that predicts an acoustic feature amount from text and a vocoder model that generates a voice waveform from the acoustic feature amount. Input data to the voice synthesis engine is a sequence of phoneme symbols and accent information. Output data from the voice synthesis engine is, for example, PCM voice waveform data with a sampling rate of 24 kHz. The output unit encodes the generated voice waveform data into a format for streaming distribution. The output unit determines a terminal type of the user. When the terminal is a smartphone, the output unit generates a card-type user interface element optimized for a touch operation. When the terminal is a digital signage, the output unit generates a screen layout including a highly visible large-character font and a QR code. The output unit packetizes all the generated display elements and voice data. The output unit transmits the packetized data to the terminal via a secure communication protocol. The dynamic multimodal content generation process by the output unit avoids a mere enumeration of text and optimizes visual and auditory information transmission. The process brings about a technical effect of improving an information understanding degree of the user and reducing a drawing processing load on the terminal side. The technical effect is optimization of communication efficiency and processing distribution between a client and a server by an advanced data conversion process on the server side. Specific application fields of the output unit include a voice navigation system for a visually impaired person, a digital signage network that simultaneously distributes emergency information in the event of a disaster in multiple languages, and the like.

A self-maintenance unit automatically detects new information or update information using an API, an RSS feed, a file monitoring function, IoT sensor cooperation, external cloud service cooperation, mail reception, CSV file automatic import, PDF document automatic analysis, bulletin board automatic reading by image recognition, voice data automatic transcription, and the like of each information management system or website, and keeps an information database in an always latest state. For example, when a garbage collection day or bus operation information is changed, it is immediately reflected in the system. The self-maintenance unit also automatically executes automatic information classification, tagging, summarization, deduplication, version management, information obsolescence detection, reliability evaluation, automatic information ranking, automatic information archiving, automatic information deletion, automatic information notification, and the like, and maintains freshness and quality of information. For example, when a plurality of manuals having the same content exist, the generative AI can compare contents, automatically select the latest and most comprehensive one, and archive old information. For example, in the event of a disaster, the self-maintenance unit can automatically collect real-time data and meteorological data from an IoT sensor, and immediately update and reflect an opening status of an evacuation shelter and safety of an evacuation route. Specifically, the self-maintenance unit constantly executes a background process for autonomously maintaining freshness and consistency of the information database. The self-maintenance unit periodically performs polling communication to an endpoint of an external system. The self-maintenance unit extracts difference data from a previous acquisition time. The self-maintenance unit receives streaming data from an IoT sensor via an MQTT protocol. The self-maintenance unit inputs the received new data or update data to a change detection module. The change detection module compares a hash value of an existing database record and a hash value of the new data. When the hash values do not match, the self-maintenance unit determines that there is a change in the data. The self-maintenance unit inputs the changed text data to a difference extraction algorithm. The self-maintenance unit specifies a changed part. The self-maintenance unit inputs the updated information to a large language model, and recalculates a summary vector of the information. The self-maintenance unit updates an index of a vector database using the recalculated summary vector. The self-maintenance unit executes a time-series analysis model for detecting obsolescence of information. Input data to the time-series analysis model is a creation date and time, a last update date and time, a time-series array of an access frequency of each piece of information, and a one-hot vector indicating a category of the information. Output data from the time-series analysis model is an obsolescence score of 0.0 to 1.0 indicating a probability that the information is still valid. The self-maintenance unit specifies information whose obsolescence score falls below a predetermined threshold value. The self-maintenance unit adds an archive flag to the specified information. The self-maintenance unit logically deletes the information to which the archive flag is added from a search target index. The self-maintenance unit executes a clustering algorithm for detecting duplicate information. The self-maintenance unit groups an information group having an extremely high similarity into one cluster. The self-maintenance unit selects a latest one having the largest information amount in the cluster as a representative record. The autonomous data life cycle management process by the self-maintenance unit prevents bloat of the database. The process brings about a technical effect of shortening an index scanning time during a search and maintaining a response speed of the entire system. The technical effect is an autonomous improvement of a computer system that continues to optimize a data structure without human intervention. Specific application fields of the self-maintenance unit include an operation schedule management system of a public transportation facility that fluctuates daily, an automatic update system of a disaster prevention hazard map that dynamically changes according to a meteorological condition, and the like.

A security management unit strictly manages a security level and a browsing authority set for each piece of information, and collates them with authority information of a user to prevent unauthorized information access. For example, an internal procedure manual, an emergency response manual, and the like that can be browsed only by an administrative staff member are prevented from being searched by a resident. The security management unit can also monitor a browsing history and a download history of information in real time, and automatically notify an administrator when a suspicious access is detected. For example, the security management unit detects a large amount of access in a short time by the same user, an access in a time zone not normally used, and the like, and issues an alert. Furthermore, security measures such as encryption of information, encryption of a communication path, long-term storage of an access log, automatic blocking at the time of information leakage, backup of information, and automatic recovery in the event of a disaster are also implemented in a multi-layered manner. Specifically, the security management unit executes strict access control and threat detection for all data flows in the system. Every time a request from a user is received, the security management unit verifies an authentication token included in a request header. The security management unit extracts an authority matrix of the user from the token. The security management unit collates a security level of information to be accessed with the authority matrix of the user. The security management unit determines whether or not access is permitted using a bit operation. The security management unit permits delivery of data to a subsequent processing module only when access is permitted. The security management unit executes an anomaly detection model that monitors network traffic and an access log of the system in real time. The anomaly detection model is an autoencoder-based neural network. Input data to the anomaly detection model is a multidimensional vector including the number of requests per unit time, a variance of a transmission source IP address, an importance score of access target information, and a statistical feature amount of a payload size. Specific examples of the input data include a numerical group such as 500 requests in the past 5 minutes, an IP address entropy of 3.2, and an average payload size of 1024 bytes. The anomaly detection model compresses an input vector into a low-dimensional latent space, and then reconstructs the input vector into an original dimension. Output data from the anomaly detection model is a reconstruction error score between the input vector and a reconstruction vector. Specific examples of the output data include a numerical value such as 0.01 for normal communication and 0.85 for abnormal communication. When the reconstruction error score exceeds a dynamically set threshold value, the security management unit determines that the communication is a sign of a cyberattack or an unauthorized access. The security management unit automatically adds a transmission source IP address determined to be abnormal to a blacklist of a firewall. The security management unit forcibly disconnects a corresponding session. The dynamic anomaly detection and automatic blocking process using machine learning by the security management unit enables a rapid response even to an unknown attack pattern. The process brings about a technical effect of minimizing an information leakage risk and improving availability of the system. The technical effect is an improvement of computer technology, which is data-driven adaptive security control that surpasses a static rule-based firewall. Specific application fields of the security management unit include an administrative core system that handles personal information and a My Number of a resident, a security gateway that protects a control network of an important infrastructure, and the like.

A log management unit records all question/answer histories, information access histories, information update histories, information deletion histories, information archive histories, information notification histories, user authentication histories, system failure histories, system maintenance histories, and the like in chronological order, and ensures transparency and traceability of system operation. For example, the log management unit can analyze at what timing and by whom specific information was referred to, what kind of questions are frequent, which information is frequently updated, and the like, and use them for system improvement and information quality improvement. For example, the log management unit can also automatically extract frequently asked questions and automatically generate and update them as an FAQ. Using log data, a usage tendency and a business process of a user are analyzed, and a highly expandable system configuration can also be realized, such as a recommendation function that proactively proposes necessary information before a user asks a question in the future, cooperation with a business automation workflow, API cooperation with an external cloud service or another local government system, city operation optimization by AI, and an automatic response in the event of a disaster. Specifically, the log management unit persists all events occurring in the system as structured data, and provides an advanced analysis infrastructure. The log management unit receives an event message asynchronously transmitted from each module by a message queuing system. The log management unit parses the received message, and extracts fields such as a time stamp, an event type, a user ID, a session ID, a processing time, and an error code. The log management unit writes the extracted data into a time-series database. The log management unit executes a sequence prediction model for analyzing an action pattern of a user using accumulated log data. The sequence prediction model is a time-series prediction model using a long short-term memory network or a Transformer. Input data to the sequence prediction model is a time-series tensor including an embedding vector of a series of search queries performed by a specific user in the past and a time stamp interval of each action. Specific examples of the input data include an array in which a vector obtained by a user searching for “moving procedure” and a vector obtained by searching for “resident card transfer” 3 minutes later are arranged in chronological order. Output data from the sequence prediction model is a prediction probability distribution of a category of information or a specific search query that the user needs next. Specific examples of the output data include a numerical group such as a search probability of 0.75 for “garbage collection calendar” and a search probability of 0.20 for “school transfer procedure”. The log management unit proactively transmits information having the highest prediction probability to the user interface unit, and causes the user interface unit to display a recommendation. The log management unit calculates a performance index of the entire system. The log management unit automatically specifies a bottleneck part where a response time exceeds a specified value. The real-time processing of large-scale log data and the execution of the prediction model by the log management unit convert passive operation of the system into active service provision. The process brings about a technical effect of reducing the number of operation steps of the user and shortening an arrival time to target information. The technical effect is an advancement of a computer system, which is self-optimization of an algorithm based on accumulated data. Specific application fields of the log management unit include a push-type administrative service proposal system according to a life event of a resident, an auto-scaling infrastructure that detects a sign of a system failure and automatically expands resources, and the like.

As described above, the embodiment of the present invention places the generative AI at the core, clarifies the role sharing between the server and the terminal, and automates and optimizes the entire process of city information search, acquisition, provision, update, and management, thereby dramatically improving the information access experience of residents and administrative staff, significantly improving the quality and efficiency of city services, and simultaneously realizing the efficiency of information management and the securing of security. Furthermore, it is an extremely practical and advanced city information integration AI system that combines scalability capable of flexibly responding to future expansion of the city and addition of new services, and robustness to operate stably even in times of disaster or emergency. Specifically, the present system completely automates a series of data pipelines from information collection to provision by closely cooperating with each of the processing units described above. The present system maps unstructured data to a high-dimensional vector space in the information collection and integration unit. The present system executes a high-speed vector operation based on cosine similarity in the search unit. The present system executes a natural language generation process using an autoregressive model in the generative AI cooperation unit. The present system executes these advanced arithmetic processes in parallel on a distributed computing environment. The present system optimizes data transfer between the processing units and minimizes latency. The present system continuously executes autonomous data update by the self-maintenance unit and dynamic threat detection by the security management unit in the background. The present system continuously improves the user experience by a predictive recommendation function using machine learning by the log management unit. These integrated processes by the present system fundamentally solve the technical problems of “information siloing” and “mismatch of search intent” that could not be solved by conventional keyword searches and static FAQ systems. The present system exhibits a remarkable technical effect of instantaneously extracting information perfectly adapted to the user's context from an enormous amount of data and presenting it in an easy-to-understand format. This technical effect is not merely an improvement in operational efficiency, but an innovation in computer technology itself, combining data structure conversion, operations in a high-dimensional space, and neural network inference. Specific application fields of the present system include a data linkage platform for a super city concept that integrally handles data provided by a plurality of administrative agencies and private companies, and a next-generation disaster prevention information system that analyzes a situation changing momentarily during a disaster in real time and presents an optimal evacuation behavior to residents.

### System Configuration

The system according to the present embodiment includes a user interface unit, an authentication and authorization unit, an information collection and integration unit, a search unit, a generative AI cooperation unit, an output unit, a self-maintenance unit, a security management unit, and a log management unit.

The user interface unit has a function that allows residents and administrative staff to access from various terminals such as a personal computer, a smartphone, a tablet, a kiosk terminal, a digital signage, a wearable device, and a voice assistant-equipped device, and input a question in a natural language through a chatbot-format screen, a voice input interface, a form input screen, a touch panel operation, reading aloud by voice synthesis, and the like. For example, it corresponds to various usage forms, such as a case where a resident inputs “Tell me the garbage collection days this week” on a smartphone application, a case where a voice input “Where is the nearest evacuation shelter?” is made on a digital signage terminal in front of a station, a case where an administrative staff member inputs “Search for the latest disaster prevention manual” on a dedicated screen of a personal computer, and a case where a foreign tourist inputs “I want to know the location of the tourist information center” on a multilingual touch panel. Furthermore, it has input assistance functions such as suggestion of a past question history, automatic completion during input, text conversion of a voice recognition result, automatic correction of typographical errors and omissions, display of a question template, automatic presentation of an FAQ according to user attributes, and push-type information presentation based on a user's behavior history and position information. Specifically, the user interface unit executes a front-end process of converting physical signals from various input devices into digital data processable by the system. The user interface unit acquires a keystroke event and tap coordinates when the user operates a touch panel or a keyboard of the terminal. The user interface unit converts the acquired event data into a text character string. When the user speaks into a microphone, the user interface unit samples an analog voice signal into digital voice waveform data by an AD converter. The digital voice waveform data is, for example, 16 kHz, 16-bit PCM data. The user interface unit inputs the voice waveform data to a voice recognition engine. The voice recognition engine is a neural network combining an acoustic model and a natural language model. Input data to the voice recognition engine is an acoustic feature amount tensor such as a mel-frequency cepstrum coefficient extracted from the voice waveform. Output data from the voice recognition engine is the recognized text character string and a reliability score of each word. The user interface unit executes an intent classification model on the input text character string. The intent classification model is a lightweight machine learning model that classifies the user's purpose from the input text. Input data to the intent classification model is a character N-gram vector of the text. Output data from the intent classification model is a label indicating an intent category such as “information search”, “procedure application”, and “facility reservation”, and a probability value thereof. The user interface unit executes dynamic switching of an input form and asynchronous acquisition processing of a suggest keyword based on the classified intent category. The user interface unit transmits the confirmed input text and accompanying metadata to the subsequent authentication and authorization unit and search unit. The multimodal input processing and real-time intent estimation processing by the user interface unit absorb user input fluctuations and erroneous operations at the system boundary. This processing brings about a technical effect of improving the quality of input data to the subsequent natural language processing module and reducing the error rate of the entire system. This technical effect is an improvement in data normalization processing in a human-machine interface. Specific application fields of the user interface unit include a kiosk terminal in a public facility that can be intuitively operated even by an elderly person or a resident unfamiliar with digital devices, and an information providing system for mobility that requires voice operation during driving.

When a resident or an administrative staff member accesses the system, the authentication and authorization unit confirms identity using multi-layered authentication means such as a resident ID, a staff ID, an individual number (My Number), face authentication, two-factor authentication, terminal authentication, position information authentication, and biometric authentication, and acquires a residential area, an age group, a language setting, an occupation, a job title, an affiliated department, used terminal information, a time stamp, a past usage history, and the like as attribute information of the user. For example, fine-grained access control is realized such that a resident is set to security level 1, an administrative staff member is set to security level 2, and a specific infrastructure administrator is set to security level 3, only public information is set as a search target for the resident, internal materials and procedure manuals are also set as search targets for the staff member, and advanced information such as an equipment inspection record and an emergency response manual is also provided to the infrastructure administrator. Specifically, the authentication and authorization unit executes strict identity verification and dynamic authorization processing based on a zero-trust architecture. The authentication and authorization unit receives an authentication request transmitted from the user interface unit. The authentication and authorization unit analyzes credential information included in the request. When biometric authentication is requested, the authentication and authorization unit receives biometric feature amount data transmitted from the terminal. The biometric feature amount data is, for example, a 512-dimensional floating-point number vector extracted from a face image. The authentication and authorization unit calculates a Euclidean distance or a cosine similarity between the received biometric feature amount vector and a template vector registered in advance in a secure database. When the calculated similarity exceeds a predetermined threshold, the authentication and authorization unit determines that the user is the person in question. The authentication and authorization unit acquires fingerprint information, an IP address, and GPS coordinates of the terminal. The authentication and authorization unit inputs these pieces of context information to a risk-based authentication model. The risk-based authentication model is a machine learning model that detects a behavior deviating from a past login history. Input data to the risk-based authentication model is a feature amount vector including a login time, latitude and longitude of position information, and a hash value of an OS version of the terminal. Output data from the risk-based authentication model is a risk score in a range of 0.0 to 1.0. When the risk score is high, the authentication and authorization unit triggers an additional two-factor authentication process. After the authentication is successful, the authentication and authorization unit inquires of a directory service to acquire the attribute information and role information of the user. The authentication and authorization unit dynamically generates an access authority matrix in the session based on the acquired information. The authentication and authorization unit embeds the generated authority matrix in an encrypted JSON web token. The authentication and authorization unit issues the token to the client terminal. The multi-factor context analysis and dynamic token generation processing by the authentication and authorization unit overcome the vulnerability of static password authentication. This processing brings about a technical effect of minimizing the risk of unauthorized access without impairing the convenience of a legitimate user. This technical effect is the realization of a secure state management mechanism combining cryptographic technology and machine learning. Specific application fields of the authentication and authorization unit include a medical information linkage network that handles highly confidential personal information, and a telework platform for administrative staff to safely access an intra-agency system from a remote work environment.

The information collection and integration unit automatically collects information from all information management systems, websites, databases, electronic bulletin boards, FAQs, business manuals, IoT sensors, external cloud services, and the like in the city, such as garbage collection, disaster prevention, child-rearing support, transportation, administrative procedures, medical care, education, local events, energy, water and sewage, environment, tourism, local communities, infrastructure monitoring, IoT sensors, meteorological data, public facility reservation, resident opinion solicitation, evacuation guidance during disasters, local safety information, road construction information, power and gas supply status, water and sewage failure information, local shopping street information, public Wi-Fi spot information, local volunteer recruitment, school lunch information, library collection information, and local sports facility usage status, to construct an integrated database. For example, various information sources are targeted, such as a garbage collection schedule management system, a disaster prevention information portal, a child-rearing support portal, a bus operation information system, an administrative procedure online application system, a medical institution guidance system, a local event management system, an energy consumption monitoring system, a water and sewage management system, a tourist guidance system, real-time data from IoT sensors, a Japan Meteorological Agency API, a public facility reservation system, a resident opinion solicitation form, an evacuation guidance application during disasters, a local safety information distribution system, a road construction information management system, a power and gas supply status monitor, a water and sewage failure information management system, a local shopping street information portal, a public Wi-Fi spot information management system, a local volunteer recruitment site, a school lunch information management system, a library collection management system, and a local sports facility usage status management system. The information collection and integration unit automatically collects information by various means such as API linkage, file monitoring, periodic crawling, Webhook reception, IoT data stream reception, external cloud service linkage, mail reception, CSV file automatic import, PDF document automatic analysis, bulletin automatic reading by image recognition, and voice data automatic transcription, and performs preprocessing such as deduplication, format unification, tagging, language determination, version management, reliability evaluation, information freshness determination, automatic classification of information, automatic summarization of information, automatic tagging of information, automatic translation of information, and automatic ranking of information. Specifically, the information collection and integration unit executes a data extraction, transformation, and loading process for integrating a group of data in heterogeneous formats distributedly arranged into a single semantic space. The information collection and integration unit activates a plurality of web crawler processes in parallel according to a set schedule. The web crawler process acquires an HTML document of a target site, analyzes a DOM tree, and extracts body text. When a PDF document is acquired, the information collection and integration unit applies a layout analysis algorithm to separate and extract paragraphs, tables, and captions of charts. The information collection and integration unit performs word division and part-of-speech tagging on the extracted text data using a morphological analyzer. The information collection and integration unit executes stop word removal and stemming processing to normalize the text. The information collection and integration unit divides the normalized text into sentence units. The information collection and integration unit inputs each divided sentence to a text embedding model. The text embedding model is a neural network obtained by fine-tuning a pre-trained language model. Input data to the text embedding model is an array of token IDs whose maximum length is limited. Output data from the text embedding model is a dense numerical vector expressing a semantic feature of each sentence. A specific example of the output data is a 384-dimensional floating-point number array. The information collection and integration unit associates the generated vector data with the original text data and metadata including an extraction source URL and a time stamp. The information collection and integration unit inserts these associated data into a vector database. The information collection and integration unit applies a moving average filter to time-series numerical data received from an IoT sensor to remove noise. The information collection and integration unit converts the numerical data after noise removal into a text character string of a predetermined format, and similarly performs vectorization processing. The normalization and vectorization processing of heterogeneous data by the information collection and integration unit eliminates search fragmentation due to format differences. This processing brings about a technical effect of enabling cross-sectional search of all information such as text, documents, and sensor data by the same algorithm in the subsequent search unit. This technical effect is an architecture improvement of an information search system by abstraction of a data structure and mapping to a high-dimensional space. Specific application fields of the information collection and integration unit include a disaster prevention dashboard that integrally analyzes river water level sensor data and past flood history reports, and a knowledge management system that centrally manages business manuals scattered across a plurality of departments.

The search unit extracts only accessible information from the information database held by the information collection and integration unit based on the authority information and attribute information of the user, converts the extracted information and the question sentence of the user into numerical vectors using a text embedding technology, and calculates a semantic similarity. For example, in response to a question “Tell me the garbage collection days this week”, information such as “Burnable garbage is collected every Tuesday and Friday, and non-burnable garbage is collected on the second and fourth Wednesdays” is determined to have the highest relevance. Furthermore, taking into consideration the freshness of information, the number of references, past user evaluations, a reliability score of information, the reliability of an information source, regional suitability, real-time data from IoT sensors, linkage with meteorological data, proximity of an event holding date and time, facility availability, and the like, the most highly relevant information is ranked, and the latest version or highly evaluated information is preferentially selected. For example, when a plurality of pieces of information having the same content exist, the latest and highly reliable information is automatically selected. The search unit can also use a combination of a plurality of text embedding models in order to improve semantic search accuracy. Furthermore, the past question history, access tendency, usage time zone, used terminal, position information, event participation history, facility usage history, resident attributes, business content of administrative staff, and the like of the user are analyzed by machine learning, thereby realizing personalized information recommendation and optimization of search results. Specifically, the search unit executes an approximate nearest neighbor search between the user's query vector and countless document vectors in the database at high speed. The search unit converts the question sentence received from the user interface unit into a query vector using the same text embedding model as the information collection and integration unit. The query vector is, for example, a 384-dimensional floating-point number array. The search unit transmits the query vector to the vector database. The vector database is constructed using an index structure such as a hierarchical navigable small world graph. The search unit extracts the top N candidate vectors having a high cosine similarity with the query vector at high speed by traversing nodes on the graph. The search unit acquires metadata corresponding to the extracted candidate vectors. The search unit compares the authority matrix of the user passed from the authentication and authorization unit with the security level of each piece of information by a bit operation. The search unit executes a filtering process of excluding information without authority from the candidate list. The search unit applies a machine learning-based reranking model to the remaining candidate information. Input data to the reranking model is a combined feature amount vector including the query vector, the vector of the candidate information, an elapsed time indicating the freshness of the information, and a past click-through rate. Output data from the reranking model is a final score from 0.0 to 1.0 indicating the degree of conformity of each piece of information in the user's current context. The search unit resorts the candidate information based on the final score. The search unit determines the top K pieces of information and outputs them to the generative AI cooperation unit. The combination of the approximate nearest neighbor search algorithm and the machine learning-based reranking by the search unit enables a response in milliseconds even for a database on a scale of millions of cases. This processing brings about a technical effect of achieving both comprehensiveness and conformity of search, and maximizing search accuracy while suppressing consumption of calculation resources. This technical effect is an improvement in computer technology, which is the optimization of a data search algorithm in a high-dimensional space. Specific application fields of the search unit include a legal support system that instantaneously identifies a related provision from an enormous amount of past judicial precedents and ordinances, and a call center support system that presents an optimal answer candidate to an operator in response to various inquiries from citizens.

The generative AI cooperation unit generates a prompt to the generative AI with the information selected by the search unit and the question sentence of the user as inputs, and causes the generative AI to generate an answer sentence in natural Japanese. For example, a prompt sentence “Question from resident: ‘Tell me the garbage collection days this week’, Reference information: ‘Burnable garbage is collected every Tuesday and Friday, and non-burnable garbage is collected on the second and fourth Wednesdays’, Based on this information, please answer clearly and concisely for residents.” is generated and read into the generative AI. The generative AI is not a mere excerpt of information, but understands the intent and context of the question, integrates and summarizes information obtained from a plurality of information sources, and creates an answer in a form easy for the user to understand. For example, in response to a question “Where is the nearest evacuation shelter?”, the nearest evacuation shelter can be identified based on the position information of the user, and an address, an opening status, map information, a barrier-free support status, a capacity, whether pets are allowed, a congestion status of the evacuation shelter, facility information of the evacuation shelter, an opening time of the evacuation shelter, contact information of the evacuation shelter, and the like can be integrated and guided. The generative AI cooperation unit can also generate a personalized answer sentence in consideration of the past question history, access tendency, and attribute information of the user. For example, even for the same question “I want to know the contents of the child-rearing support system”, a nursery school usage subsidy and a childcare consultation counter can be automatically guided to a family with an infant, an after-school childcare and an education support fund can be automatically guided to a family with a school-age child, and multilingual guidance can be automatically guided to a foreign resident. In addition, when information is managed in a plurality of languages, multilingual support by the generative AI can be realized, and an answer sentence can be automatically translated and generated according to the language setting of the user. For example, when a foreign resident asks a question “Where is the nearest evacuation shelter?” in English, the address, map, and opening status of the nearest evacuation shelter can be guided in English, and a link to a multilingual evacuation shelter guidance page can also be presented. Furthermore, for administrative staff, the generative AI can also generate advanced answers that support operational efficiency and rapid decision-making, such as information on legal revisions, main points of business manuals, emergency response procedures, summaries of equipment inspection records, and automatic generation of instruction documents during disasters. Specifically, the generative AI cooperation unit executes a retrieval-augmented generation process that controls an inference process of a large language model by utilizing the context information obtained from the search unit. The generative AI cooperation unit buffers the top K related information texts output from the search unit on a memory. The generative AI cooperation unit combines the question sentence of the user, the attribute information of the user, and the buffered related information texts into a predetermined prompt template. The generative AI cooperation unit inputs the combined character string to a tokenizer and converts it into a sequence of token IDs. The generative AI cooperation unit supplies the sequence of token IDs to an input layer of the large language model. The large language model has a structure in which decoder blocks of a transformer are stacked in multiple layers. A specific example of input data to the large language model is an integer array having a length of, for example, 2048 tokens, in which a system instruction, context information, and a user question are concatenated. The large language model calculates a dependency relationship between input tokens using an attention mechanism. The large language model outputs a probability distribution tensor having dimensions corresponding to a vocabulary size via a softmax function of an output layer. As a specific example of the probability distribution tensor, when the vocabulary size is 50000, an array in which each element of 50000 dimensions has a probability value of 0.0 to 1.0 is given. The generative AI cooperation unit selects a token to appear next from the probability distribution tensor using a beam search algorithm or a top-p sampling method. The generative AI cooperation unit adds the selected token to the end of the input sequence, and repeats the inference process autoregressively until an end token is output. The generative AI cooperation unit inversely converts the generated token sequence into a natural language text character string by a detokenizer. The generative AI cooperation unit executes a process of automatically embedding a URL or a document ID of a referenced information source as a quotation mark in the generated text character string. The retrieval-augmented generation process by the generative AI cooperation unit enables the large language model to generate an answer by referring to the latest information or undisclosed internal information not included in learning data. This processing brings about a technical effect of suppressing hallucination and realizing accurate information provision based on facts. This technical effect is an architecture improvement that dynamically couples an external database and an inference engine of a neural network. Specific application fields of the generative AI cooperation unit include a tax consultation AI that generates an answer based on the latest tax system revision information in response to a complex tax consultation, and a maintenance support system that automatically generates a troubleshooting guide for a device reflecting revised contents of a manual.

The output unit returns the answer sentence generated by the generative AI to the user interface on the terminal side, and presents it to the user by various means such as a chatbot screen, a notification function, an email, an SMS, a push notification, a digital signage display, reading aloud by voice synthesis, and smart speaker linkage. For example, in addition to displaying the answer sentence on the chatbot screen, it is also possible to automatically insert a link to a related web page, an application form, map information, related materials, an image, a video, a chart, and reference materials as necessary. For example, in response to a question “Tell me the bus operation status”, a current operation status, delay information, a timetable of the nearest bus stop, a map of an operation route, a prospect of operation resumption, a link to a bus location system, contact information of a bus company, and the like can be integrated and presented. For example, in response to a question “I want to know the holding schedule of local events”, an event name, a holding date and time, a holding place, a participation application method, a participation fee, organizer information, a past holding record, information on a related local shopping street, a link to an official website of the event, a link to an SNS account of the event, a map of an event venue, a congestion forecast of the event, a weather response policy of the event, and the like can also be guided at the same time. Specifically, the output unit executes a data formatting process of converting the plain text output from the generative AI cooperation unit into a rich media format optimized for the user's context. The output unit inputs the generated answer text to a syntax analyzer. The output unit extracts a specific keyword or data pattern in the text. When the extracted data pattern indicates a date and time range, the output unit generates a data block in an iCalendar format for linking with a calendar application. When the extracted data pattern indicates position information, the output unit generates a parameter set for calling a map drawing API. The output unit integrates the answer text and these additional data blocks to construct a JSON payload for front-end drawing. A specific example of input data to the JSON payload is structured data including a main text of the answer, a URL array of related links, and latitude and longitude coordinates for map display. When the user's terminal is a smart speaker or a voice assistant, the output unit converts the answer text into a speech synthesis markup language format. The output unit inputs the markup language data to a speech synthesis model. Output data from the speech synthesis model is voice waveform data reflecting specified speaker characteristics and emotion parameters. The output unit transmits the generated JSON payload or voice waveform data to the client terminal as an HTTPS response or a WebSocket stream. The output unit updates a session state after completion of transmission, and holds a context ID in preparation for the next dialogue. The dynamic data format conversion and multimodal output generation processing by the output unit automatically derive an optimal expression for various devices from a single text generation result. This processing brings about a technical effect of simplifying implementation on the client side, improving maintainability of the entire system, and reducing a cognitive load on the user. This technical effect is optimization of a communication payload by execution of advanced presentation logic on the server side. Specific application fields of the output unit include an omnichannel information distribution platform that provides information in an optimal format from the same back end to a smartphone application, a web browser, and a digital signage in front of a station.

The self-maintenance unit automatically detects new information or update information using an API, an RSS feed, a file monitoring function, IoT sensor linkage, external cloud service linkage, mail reception, CSV file automatic import, PDF document automatic analysis, bulletin automatic reading by image recognition, voice data automatic transcription, and the like of each information management system or website, and keeps the information database in an always latest state. For example, when a garbage collection day or bus operation information is changed, it is immediately reflected in the system. Automatic classification of information, tagging, summarization, deduplication, version management, information obsolescence detection, reliability evaluation, automatic ranking of information, automatic archiving of information, automatic deletion of information, automatic notification of information, and the like are also automatically executed to maintain the freshness and quality of information. For example, when a plurality of manuals having the same content exist, the generative AI can compare the contents, automatically select the latest and most comprehensive one, and archive old information. For example, during a disaster, real-time data and meteorological data from IoT sensors can be automatically collected, and the opening status of evacuation shelters and the safety of evacuation routes can be immediately updated and reflected. Specifically, the self-maintenance unit executes an autonomous data synchronization and cleansing pipeline for maintaining the completeness and freshness of the information database. The self-maintenance unit holds a list of registered external data sources on a memory. The self-maintenance unit periodically activates a fetch process for each data source using an asynchronous task scheduler. The self-maintenance unit receives a response in an XML or JSON format from an RSS feed or an API endpoint. The self-maintenance unit extracts a unique identifier and a last update time stamp from the received data. The self-maintenance unit compares the extracted time stamp with a time stamp of an existing record in the database. When the time stamp is new, the self-maintenance unit executes an update process of the record. The self-maintenance unit inputs the updated text data to a natural language processing pipeline. The self-maintenance unit executes a text summarization model. Input data to the summarization model is a long text sequence. Output data from the summarization model is a short text sequence holding an important context. The self-maintenance unit inputs the summarized text to the text embedding model to generate a new vector representation. The self-maintenance unit overwrites and updates an index of the vector database using the generated vector. The self-maintenance unit periodically executes a broken link check process for all records in the database. The self-maintenance unit identifies a record including a URL for which an HTTP status code returns 404. The self-maintenance unit subtracts a reliability score of the identified record. The self-maintenance unit automatically moves a record whose reliability score falls below a threshold to an archive table. The autonomous data synchronization and cleansing processing by the self-maintenance unit prevents deterioration of search quality due to information obsolescence or dead links. This processing brings about a technical effect of eliminating manual maintenance work by a system administrator and always guaranteeing a highly accurate search result. This technical effect is realization of a continuous self-repair function of a data structure by a background process. Specific application fields of the self-maintenance unit include a legal information system that automatically synchronizes a database of laws and ordinances updated daily to the latest state, and a meteorological information platform that collects data from a plurality of meteorological APIs, excludes abnormal values, and integrates them.

The security management unit strictly manages a security level and a viewing authority set for each piece of information, and collates them with the authority information of the user to prevent unauthorized information access. For example, an internal procedure manual, an emergency response manual, or the like that can be viewed only by administrative staff is prevented from being searched by residents. It is also possible to monitor an information viewing history and a download history in real time, and automatically notify an administrator when suspicious access is detected. For example, a large amount of access in a short time by the same user, access in a time zone not normally used, or the like is detected, and an alert is issued. Furthermore, security measures such as information encryption, communication path encryption, long-term storage of access logs, automatic blocking at the time of information leakage, information backup, and automatic recovery at the time of disaster are also implemented in a multi-layered manner. Specifically, the security management unit monitors data access inside and outside the system, and executes policy-based access control and automatic threat blocking. The security management unit functions as a proxy module that intercepts all API requests. The security management unit verifies a signature of a JSON web token included in the request using a public key cryptosystem. When the signature is valid, the security management unit extracts a role ID and an affiliated group ID of the user from a payload of the token. The security management unit acquires an access control list given to a resource to be accessed from a database. The security management unit collates the role ID of the user with the access control list to determine presence or absence of a read or write authority. When there is no authority, the security management unit immediately returns an error response including an HTTP status code 403 and blocks the processing. Even if the access is permitted, the security management unit inputs the access pattern to a behavior detection engine. The behavior detection engine is a time-series anomaly detection model using a recurrent neural network. Input data to the behavior detection engine is a time-series feature amount tensor including a past access time, an access frequency, and a confidentiality level of the resource of the user. Output data from the behavior detection engine is an anomaly score indicating a probability that the current access deviates from a normal profile. Specific examples of the output data include numerical values such as 0.05 for access within normal business hours and 0.92 for a large amount of downloading in a midnight time zone. When the anomaly score exceeds a threshold value, the security management unit temporarily locks the account of the user. The security management unit transmits an alert event to a dashboard of the administrator. The security management unit encrypts all text data and vector data stored in the database using an AES-256 algorithm. The dynamic access control and the machine learning-based behavior detection processing by the security management unit prevent information leakage due to an internal crime or account hijacking in real time. This processing brings about a technical effect of strongly protecting confidentiality and integrity of the system. This technical effect is realization of an advanced security architecture integrating static access authority management and dynamic threat detection. Specific application fields of the security management unit include a local government cloud system requiring high security that handles tax information and health information of residents, a knowledge base for a research and development department that manages confidential design data of a company, and the like.

The log management unit records all question/answer histories, information access histories, information update histories, information deletion histories, information archive histories, information notification histories, user authentication histories, system failure histories, system maintenance histories, and the like in chronological order to ensure transparency and traceability of system operation. For example, it is possible to analyze at what timing and by whom specific information was referred to, what kind of questions are frequent, which information is frequently updated, and the like, and use the analysis for system improvement and information quality improvement. For example, it is also possible to automatically extract frequently asked questions and automatically generate and update them as an FAQ. By analyzing a usage tendency and a business process of the user using log data, it is also possible to realize a highly expandable system configuration such as a recommendation function of proactively proposing necessary information before the user asks a question in the future, cooperation with a business automation workflow, API cooperation with an external cloud service or another local government system, city operation optimization by AI, and automatic response at the time of disaster. Specifically, the log management unit records all transactions occurring in the system as an immutable event stream, and provides a data-driven system improvement infrastructure. The log management unit collects structured log messages output from each processing module via a distributed streaming platform. The log management unit accumulates the collected log messages in a data lake. The log message includes a time stamp, a request ID, a user ID, an executed function name, a latency in milliseconds required for processing, and an amount of consumed memory. The log management unit periodically executes batch processing on the accumulated log data. In the batch processing, the log management unit inputs text data of the question sentence of the user to a clustering algorithm. The clustering algorithm is, for example, a K-Means method or DBSCAN. Input data to the clustering algorithm is a high-dimensional feature amount obtained by vectorizing the question sentence. Output data from the clustering algorithm is an array of cluster IDs to which each question sentence belongs. The log management unit aggregates a frequency of questions belonging to the same cluster. The log management unit extracts a cluster whose frequency exceeds a predetermined threshold value as a candidate for “frequently asked questions”. The log management unit automatically generates a new FAQ record by pairing a representative question sentence of the extracted cluster and an answer history of the generative AI to the representative question sentence. The log management unit feeds back the generated FAQ record to the database of the information collection and integration unit. The log management unit inputs a latency log of the system to a time-series prediction model. Output data from the time-series prediction model is a predicted value of a system load in a specific time zone in the future. The log management unit issues an API call instructing a container orchestration system to scale out resources based on the predicted value. The analysis of the large-scale log and the execution of the feedback loop by the log management unit autonomously optimize content and resource allocation of the system. This processing brings about a technical effect of rapidly adapting to changes in user needs while reducing operation costs. This technical effect is an improvement in computer technology that sublimates log data from a mere record to an input parameter for system control. Specific application fields of the log management unit include a dynamic portal site that automatically converts specific inquiries that rapidly increase when a disaster occurs into an FAQ and posts it on a top page, a cloud-native administrative system that automatically adjusts server resources based on access prediction, and the like.

Specific examples of a prompt sentence to be read by the generative AI when carrying out the present invention include “Question from resident: ‘Tell me the garbage collection days this week’, Reference information: ‘Burnable garbage is collected every Tuesday and Friday, and non-burnable garbage is collected on the second and fourth Wednesdays’, Based on this information, please answer clearly and concisely for residents.”, “Question from administrative staff: ‘Search for the latest disaster prevention manual’, Reference information: ‘The disaster prevention manual revised in April 2024 includes evacuation guidance procedures during a disaster, an emergency contact network, shelter opening procedures, and relief supply distribution methods during a disaster.’, Based on this information, please summarize the main points and answer for administrative staff.”, “Question from foreign resident: ‘Where is the nearest evacuation shelter?’, Reference information: ‘The nearest evacuation shelter is XX Elementary School, the address is 1-2-3 XX-cho, XX-ku, currently open, barrier-free, pets allowed’, Based on this information, please answer clearly in English.”, and the like. Specifically, the system executes structured prompt engineering processing in order to maximize inference accuracy of the generative AI. In a prompt generation module, the system combines an input text of the user, context data acquired from the search unit, and a constraint condition defined by the system to construct a character string according to a specific format. Input data to the prompt generation module is a question character string of the user, a character string array of searched reference information, and metadata indicating an attribute of the user (for example, general resident, administrative staff, foreigner, etc.). The prompt generation module converts these pieces of input data into a JSON format or a structured text enclosed by a specific markup tag. Output data from the prompt generation module is a final prompt character string input to a large language model. Specific examples of the output data include a character string such as “Role: You are a kind local government assistant. Constraint: Please answer based only on the following reference information. Reference information: ‘Burnable garbage is collected every Tuesday and Friday, and non-burnable garbage is collected on the second and fourth Wednesdays’. Question: ‘Tell me the garbage collection days this week’. Output format: Concise Japanese text.”. The system supplies the constructed prompt character string to an input layer of the large language model. The large language model analyzes a context of the input prompt and generates an output token according to the instructed role and constraint condition. Output data from the large language model is a natural language text character string strictly following the instruction of the prompt. The dynamic generation processing of the structured prompt by the system suppresses fluctuation in the output of the large language model and forces answer generation in a consistent format. This processing brings about a technical effect of preventing hallucination and stably obtaining a highly reliable output conforming to business requirements. This technical effect is an improvement in a control method for optimizing and operating a general-purpose neural network model for a specific domain task. Specific application fields of the prompt generation processing include a legal tech system that generates a strict answer based only on related laws and regulations in legal consultation, a medical information providing system that supports a diagnosis of a doctor based on medical guidelines, and the like.

### Implementation Steps

Step 1: Question Reception/User Authentication A resident or an administrative staff member inputs a question in a natural language from various terminals such as a personal computer, a smartphone, a tablet, a kiosk terminal, a digital signage, a wearable device, and a voice assistant-equipped device through a chatbot screen, voice input, form input, touch panel operation, or the like, and the user interface unit receives the question. The authentication and authorization unit confirms identity using multi-layered authentication means such as a resident ID, a staff ID, an individual number, face authentication, two-factor authentication, terminal authentication, position information authentication, and biometric authentication, and acquires attribute information such as a residential area, an age group, a language setting, an occupation, a job title, an affiliated department, used terminal information, a time stamp, and a past usage history. Specifically, as a first stage of processing, the system executes processing of capturing input data from a client terminal and establishing a secure session. The user interface unit of the system receives an HTTP request transmitted from a browser or an application of the client terminal via a reverse proxy. The user interface unit extracts text data or voice waveform data of a natural language input by the user from a payload of the request. The user interface unit temporarily stores the extracted data in a buffer on a memory. The authentication and authorization unit of the system extracts an authentication token or biometric authentication data included in a request header. The authentication and authorization unit transmits the extracted authentication data to an authentication server and executes verification processing. Input data to the authentication server is a hash value of a user ID and a password, or an embedding vector of a face image. Output data from the authentication server is a Boolean value indicating success or failure of authentication, and a JSON object including profile information of the user. Specific examples of the output data include data in which an authentication success flag is True and profile information is “Affiliated department: Citizens' Affairs Division, Job title: General staff, Security level: 2”. When the authentication is successful, the authentication and authorization unit creates a new session record in a session management database. The authentication and authorization unit associates the generated session ID with the attribute information of the user and stores them in a cache memory. The system combines the input question data and the established session information, and passes the data to a subsequent search processing step. The integration of the input reception and the multi-layered authentication processing by the system blocks an inflow of unauthorized data into the system at an edge level. This processing brings about a technical effect of ensuring that subsequent heavy natural language processing and search processing are executed only for a request of a legitimate user, thereby preventing waste of calculation resources. This technical effect is establishment of a secure data entry point and realization of a resource protection mechanism in a distributed system. Specific application fields of this step include front-end processing of a public web portal where access by an unspecified large number of people is assumed, an initial response phase of a chatbot for customers of a financial institution requiring strict access control, and the like.
Step 2: Information Collection and Integration The information collection and integration unit automatically collects information from all information management systems, websites, databases, electronic bulletin boards, FAQs, business manuals, IoT sensors, external cloud services, and the like in the city, such as garbage collection, disaster prevention, child-rearing support, transportation, administrative procedures, medical care, education, local events, energy, water and sewage, environment, tourism, local communities, infrastructure monitoring, IoT sensors, meteorological data, public facility reservation, resident opinion solicitation, evacuation guidance during a disaster, local safety information, road construction information, power and gas supply status, water and sewage failure information, local shopping street information, public Wi-Fi spot information, local volunteer recruitment, school lunch information, library collection information, and local sports facility usage status, stores the information in an integrated database by various means such as API cooperation, file monitoring, periodic crawling, Webhook reception, IoT data stream reception, external cloud service cooperation, mail reception, CSV file automatic import, PDF document automatic analysis, automatic reading of posted materials by image recognition, and automatic transcription of voice data, and performs preprocessing such as deduplication, format unification, tagging, language determination, version management, reliability evaluation, information freshness determination, automatic information classification, automatic information summarization, automatic information tagging, automatic information translation, and automatic information ranking. Specifically, the information collection and integration unit establishes connections to a plurality of distributed external systems using an asynchronous communication protocol. The information collection and integration unit executes periodic polling processing and event-driven push notification reception processing in parallel. The information collection and integration unit expands the acquired unstructured data and semi-structured data on a memory in a temporary storage area. The information collection and integration unit executes normalization processing of a data format. The information collection and integration unit applies optical character recognition processing using a convolutional neural network to image data. The information collection and integration unit extracts a feature map from an input image tensor. The information collection and integration unit converts the extracted feature map into an array of character codes. The information collection and integration unit applies voice recognition processing using a recurrent neural network to voice data. The information collection and integration unit converts a time-series array of input acoustic feature amounts into text data. The information collection and integration unit executes preprocessing of text data using a natural language processing model. The natural language processing model removes stop words from the input text data. The natural language processing model executes morphological analysis to extract a basic form of a word. The information collection and integration unit inputs the preprocessed text data to a classification neural network. The classification neural network processes a word embedding vector of the input text. The classification neural network calculates a probability distribution for a predefined category group as an output. For example, the classification neural network outputs a probability of a garbage collection category as 0.85 and a probability of a disaster prevention category as 0.05 for the input text. The information collection and integration unit gives a category indicating the highest probability as metadata of the data. The information collection and integration unit executes automatic summarization of long text data using a summarization neural network. The summarization neural network extracts an important context vector from a token array of the input long text. The summarization neural network generates a token array of a compressed summary text as an output. The information collection and integration unit associates the generated summary text with original data and stores them in the integrated database. The information collection and integration unit calculates a hash value of each piece of data as deduplication processing. The information collection and integration unit compares the calculated hash value with a hash value of existing data. The information collection and integration unit skips saving of new data when a matching hash value exists. The information collection and integration unit eliminates data silos by these processes. The information collection and integration unit significantly reduces a calculation load in subsequent search processing. The information collection and integration unit brings about a technical effect of dramatically improving information search accuracy. The system is optimally applied to a use case such as an integrated information infrastructure in a smart city.
Step 3: Semantic Search and Information Extraction The search unit extracts only accessible information from the information database held by the information collection and integration unit based on the authority information and the attribute information of the user, converts the extracted information and the question sentence of the user into numerical vectors using a text embedding technology, and calculates a semantic similarity. The search unit ranks the most relevant information by also taking into consideration newness of information, the number of references, user evaluation, a reliability score, reliability of a sender, regional suitability, real-time data from an IoT sensor, meteorological data, proximity of an event holding date and time, facility availability, and the like, and preferentially selects the latest and highly reliable information. Specifically, the search unit acquires an authority flag and an attribute parameter from an authentication session of the user. The search unit dynamically generates an access control filter for the integrated database using the acquired authority flag. The search unit applies the generated filter to narrow down a data group to be searched. The search unit inputs the question sentence in a natural language input by the user to a text encoder model. The text encoder model has a multi-layered neural network architecture provided with a self-attention mechanism. The text encoder model tokenizes the input question sentence. For example, the text encoder model converts a question sentence “when is the garbage collection day” into an array of a plurality of token IDs. The text encoder model converts the array of token IDs into a dense vector in a high-dimensional space. The text encoder model generates, for example, a 768-dimensional floating-point numerical array as an output. The search unit constructs a vector index by executing similar vectorization processing in advance on each text of the narrowed-down data group. The search unit calculates a cosine similarity between the dense vector of the question sentence and each dense vector of the data group. The search unit holds the calculated similarity score as a base score. The search unit executes weighting scoring processing based on metadata. The search unit calculates an elapsed time from an update date and time of data. The search unit calculates a freshness score that becomes a higher value as the elapsed time is shorter. The search unit calculates a reliability score from the past number of references and a user evaluation value. The search unit calculates a final ranking score by linearly combining the freshness score and the reliability score with respect to the base score. The search unit sorts the data in descending order of the ranking score. The search unit extracts a predetermined number of top data as related information. The search unit provides the extracted related information as an input context for subsequent answer generation processing. The search unit realizes semantic information search that does not depend on mere keyword matching. The search unit absorbs orthographical variants and differences in synonyms. The search unit exhibits a technical effect of extracting information matching a true intention of the user with high accuracy. The system functions extremely effectively in use cases such as a portal site for residents of a local government and an internal help desk of a company.
Step 4: Answer Generation by Generative AI The generative AI cooperation unit generates a prompt to the generative AI with the information selected by the search unit and the question sentence of the user as inputs, and causes the generative AI to generate an answer sentence in natural Japanese. For example, specific examples of the prompt sentence include “Question from resident: ‘Tell me the garbage collection days this week’, Reference information: ‘Burnable garbage is collected every Tuesday and Friday, and non-burnable garbage is collected on the second and fourth Wednesdays’, Based on this information, please answer clearly and concisely for residents.”, “Question from administrative staff: ‘Search for the latest disaster prevention manual’, Reference information: ‘The disaster prevention manual revised in April 2024 includes evacuation guidance procedures during a disaster, an emergency contact network, shelter opening procedures, and relief supply distribution methods during a disaster.’, Based on this information, please summarize the main points and answer for administrative staff.”, and the like. The generative AI understands an intention and a context of the question, integrates and summarizes information obtained from a plurality of information sources, and creates an answer in a form easy for the user to understand. Specifically, the generative AI cooperation unit receives text data of the related information extracted from the search unit. The generative AI cooperation unit dynamically constructs a prompt character string by combining the question sentence of the user and the text data of the related information. The generative AI cooperation unit inputs the constructed prompt character string to a large language model. The large language model is a deep learning model having billions to hundreds of billions of parameters. The large language model tokenizes the input prompt character string in subword units. The large language model converts each token into a multidimensional embedding vector. The large language model calculates a contextual dependency relationship between tokens using a self-attention mechanism. The large language model predicts a token having the highest probability of appearing next based on an input context. The large language model generates an array of probability distributions for all tokens in a vocabulary dictionary as an output. For example, the large language model outputs a probability of Tuesday as 0.92 and a probability of Wednesday as 0.05 as the next token. The generative AI cooperation unit executes decoding processing of selecting the most appropriate token from the probability distribution. The generative AI cooperation unit feeds back the selected token to the large language model as a new input. The generative AI cooperation unit repeats this autoregressive generation process until an end token is output. The generative AI cooperation unit decodes the generated token sequence into a natural language text character string. The generative AI cooperation unit executes filtering processing of evaluating quality of the generated answer sentence. The generative AI cooperation unit verifies whether an inappropriate expression or a contradiction is included in the answer sentence. The generative AI cooperation unit determines the answer sentence that has passed the verification as final output data. The generative AI cooperation unit transfers the determined answer sentence to a subsequent output processing module. The generative AI cooperation unit logically integrates fragmentary information distributed in a plurality of information sources. The generative AI cooperation unit automatically generates a summary sentence that can be directly understood by the user. The generative AI cooperation unit brings about a technical effect of dramatically reducing a cognitive load for the user to read and understand a plurality of documents. The system is applied to a use case requiring advanced information integration, such as guidance on complicated administrative procedures and explanation of technical manuals.
Step 5: Personalization and Multilingual Support The generative AI cooperation unit generates a personalized answer sentence in consideration of a past question history, an access tendency, and attribute information (residential area, age group, language setting, occupation, etc.) of the user. For example, even for the same question “I want to know the contents of the child-rearing support system”, it is possible to automatically guide a household with an infant to a nursery school usage subsidy and a childcare consultation counter, a household with a school-age child to an after-school childcare and an education support fund, and a foreign resident to multilingual guidance. In addition, when information is managed in a plurality of languages, it is also possible to realize multilingual support by the generative AI and automatically translate and generate an answer sentence according to the language setting of the user. Specifically, the generative AI cooperation unit accesses a profile database using an identifier of the user as a key. The generative AI cooperation unit acquires a past search history, a browsing history, and registered attribute information of the user. The generative AI cooperation unit digitizes the acquired history data and attribute information to generate a user profile vector. The generative AI cooperation unit uses the user profile vector as a conditioning parameter of a large language model. The generative AI cooperation unit inserts a system instruction according to the attribute of the user at the head of a prompt character string. The generative AI cooperation unit provides the large language model with context information that, for example, a target reader is a guardian in his/her 30s having an infant. The large language model dynamically adjusts a tone and a vocabulary of an output text based on the input context information. When the language setting of the user is a foreign language, the large language model executes cross-lingual generation processing. The large language model maps the input Japanese reference information to an internal multilingual latent space. The large language model outputs a token probability distribution of a designated target language. For example, when English is designated, the large language model generates an array of probability distributions for an English vocabulary as an output. The generative AI cooperation unit formats the generated multilingual answer sentence into a format suitable for a user interface. The generative AI cooperation unit transfers the personalized answer sentence to a subsequent output processing module. The generative AI cooperation unit breaks away from uniform information provision. The generative AI cooperation unit provides information optimized for a situation and needs of each user. The generative AI cooperation unit exhibits a technical effect of preventing an information mismatch and significantly shortening a time until the user achieves a purpose. The system shows extremely high usefulness in use cases such as a comprehensive guidance service of a local government used by residents of various nationalities and age groups, and a support desk for employees of a global company.
Step 6: Answer Presentation and Related Information Addition The output unit returns the answer sentence generated by the generative AI to the user interface on the terminal side, and presents it to the user by various means such as a chatbot screen, a notification function, an email, an SMS, a push notification, a digital signage display, reading aloud by voice synthesis, and smart speaker cooperation. If necessary, it is also possible to automatically insert a link to a related web page, an application form, map information, or related materials, an image, a moving image, a chart, or a link to reference materials. Specifically, the output unit receives text data of the determined answer sentence from the generative AI cooperation unit. The output unit determines a device type and a network bandwidth of the terminal used by the user. The output unit optimizes a data format of the answer sentence based on a determination result. The output unit extracts an important entity from the text data using a named entity extraction model. The named entity extraction model specifies an entity such as a facility name, a URL, or a telephone number from the input text. The output unit dynamically generates a hyperlink or an action button corresponding to the extracted entity. The output unit constructs a structured document by inserting the generated link or button at an appropriate position in the answer sentence. When the user uses a voice interface, the output unit activates a text-to-speech synthesis model. The text-to-speech synthesis model converts the input text data into an array of phonemes. The text-to-speech synthesis model generates a spectrogram of an acoustic feature amount from the array of phonemes. The text-to-speech synthesis model synthesizes voice waveform data from the spectrogram using a vocoder network. The output unit transmits the synthesized voice waveform data to the user terminal in a streaming format. For a visual interface, the output unit transmits data for rendering in an HTML or JSON format. The output unit controls so that the answer sentence is immediately displayed or reproduced on the terminal of the user. The output unit realizes interactive information presentation that allows the user to immediately take a next action, rather than a mere enumeration of texts. By supporting a multimodal output format, the output unit brings about a technical effect of dramatically improving accessibility for all users including visually impaired persons and elderly persons. The system is applied to an omnichannel service having various touch points, such as a digital signage installed in a station or a city hall, a smartphone application, and a smart speaker.
Step 7: Self-Maintenance and Automatic Information Update. The self-maintenance unit automatically detects new information and update information using APIs and RSS feeds of each information management system and website, a file monitoring function, IoT sensor cooperation, external cloud service cooperation, email reception, automatic CSV file import, automatic PDF document analysis, automatic reading of posted materials by image recognition, automatic transcription of voice data, and the like, and keeps the information database in an always latest state. The self-maintenance unit also automatically executes automatic classification, tagging, summarization, deduplication, version management, information obsolescence detection, reliability evaluation, automatic information ranking, automatic information archiving, automatic information deletion, automatic information notification, and the like of information, and maintains the freshness and quality of the information. Specifically, the self-maintenance unit operates as a background process resident inside the system. The self-maintenance unit executes a polling process for an external data source according to a preset schedule. The self-maintenance unit sends an HTTP request to an API endpoint of an external system. The self-maintenance unit extracts an update date and time field from JSON data acquired as a response. The self-maintenance unit compares the extracted update date and time with a last synchronization date and time in the integrated database. The self-maintenance unit downloads difference data only when the update date and time is newer. The self-maintenance unit executes a data cleansing process on the downloaded difference data. The self-maintenance unit evaluates the validity of existing data using an obsolescence detection model. The obsolescence detection model processes a creation date and time, an access frequency, and a feature amount vector of text content of the input data. The obsolescence detection model calculates, as an output, a probability score indicating whether the data is still valid. For example, the obsolescence detection model outputs a low score of a valid probability of 0.12 for past event information. The self-maintenance unit automatically moves data whose valid probability falls below a predetermined threshold to an archive area. The self-maintenance unit excludes the archived data from an index to be searched. The self-maintenance unit applies an automatic tagging model to newly added data. The automatic tagging model extracts a keyword from input text and outputs a list of related tags. The self-maintenance unit reconstructs a vector index for search using the updated data group. The self-maintenance unit completely eliminates manual data maintenance work by a human administrator. The self-maintenance unit always maintains the freshness and accuracy of the information database at the highest level. The self-maintenance unit exhibits a technical effect of preventing generation of an erroneous answer based on old information. The system is optimal for use cases such as a news distribution platform where a huge amount of information is updated daily and an administrative procedure database that needs to frequently respond to legal revisions.

Step 8: Security Management and Access Control. The security management unit strictly manages a security level and a viewing authority set for each piece of information, and collates them with the authority information of the user to prevent unauthorized information access. Internal procedure manuals, emergency response manuals, and the like that can be viewed only by administrative staff are made unsearchable by residents, viewing histories and download histories of information are monitored in real time, and when a suspicious access is detected, an administrator is automatically notified. Security measures such as information encryption, communication path encryption, long-term storage of access logs, automatic blocking at the time of information leakage, information backup, and automatic recovery at the time of disaster are also implemented in a multi-layered manner. Specifically, the security management unit functions as a proxy layer that intercepts all data access requests in the system. The security management unit verifies an authentication token included in the access request. The security management unit extracts role information and a security clearance level of the user from the authentication token. The security management unit collates an access control list given to the requested data object with the role information of the user. The security management unit immediately returns an access denial error when the authority is insufficient. The security management unit executes real-time monitoring of an access pattern using an anomaly detection neural network. The anomaly detection neural network receives, as an input, a time-series feature amount vector such as an access frequency of the user, geographical information of an IP address, and a payload size of a request. The anomaly detection neural network adopts an autoencoder architecture. The anomaly detection neural network compresses the input vector into a low-dimensional latent space and then reconstructs it to the original dimension. The anomaly detection neural network outputs a reconstruction error between the input vector and the reconstruction vector as an anomaly score. For example, the anomaly detection neural network outputs a low anomaly score of 0.05 for a normal access, and outputs a high anomaly score of 0.89 for an access attempting to download a large amount of confidential data in a short time. When the anomaly score exceeds a set threshold, the security management unit forcibly disconnects a session of the user. The security management unit blocks communication from a target IP address at a firewall level. The security management unit immediately notifies a dashboard of a system administrator of detailed information of an incident. The security management unit applies an advanced encryption algorithm to stored data in the database. The security management unit reduces an information leakage risk due to an internal crime or an external cyber attack to the utmost limit. The security management unit brings about a technical effect of providing a robust security infrastructure that achieves both availability and confidentiality of the system. The system becomes an essential component in use cases such as a healthcare system that handles personal information and medical data, and a network of a government agency that manages national secrets.

Step 9: Log Management and Usage Tendency Analysis. The log management unit records all question/answer histories, information access histories, information update histories, information deletion histories, information archive histories, information notification histories, user authentication histories, system failure histories, system maintenance histories, and the like in chronological order to ensure transparency and traceability of system operation. The log management unit analyzes at what timing and by whom specific information was referred to, what kind of questions are frequent, which information is frequently updated, and the like, and utilizes them for system improvement and information quality improvement. By analyzing the usage tendency and business process of the user using log data, a highly expandable system configuration such as a recommendation function that proactively proposes necessary information before the user asks a question in the future, cooperation with a business automation workflow, API cooperation with an external cloud service or another local government system, city operation optimization by AI, and automatic response at the time of disaster can be realized. Specifically, the log management unit asynchronously captures all transaction events occurring in the system. The log management unit converts the captured event data into a structured JSON format. The log management unit additionally stores the converted log data in a distributed data store in chronological order. The analysis engine periodically executes batch processing on the accumulated log data. The analysis engine extracts a topic from the question history of the user using a natural language processing model. The analysis engine groups similar questions using a clustering algorithm. The analysis engine receives an embedding vector group of each question sentence as an input. The analysis engine generates a centroid vector of each cluster and a frequency distribution of questions belonging to the cluster as an output. The analysis engine predicts a future search trend using a time-series prediction model. The time-series prediction model has a long short-term memory network architecture. The time-series prediction model receives a time-series array of past topic frequencies as an input. The time-series prediction model calculates a predicted value of a topic frequency in a specific future period as an output. The analysis engine loads information expected to increase in demand into a cache memory in advance based on the prediction result. The analysis engine generates recommendation information for the user using a collaborative filtering algorithm. The analysis engine specifies another user group having an action history similar to that of a specific user. The analysis engine outputs information highly evaluated by the other user group as a recommendation candidate to the user. The log management unit and the analysis engine quantitatively visualize the usage status of the system. The log management unit and the analysis engine establish a data-driven system improvement cycle. The log management unit and the analysis engine exhibit a technical effect of realizing proactive information provision that proactively presents necessary information before the user explicitly performs a search. The system is widely applied to use cases such as a data analysis platform for reflecting citizens' voices in municipal administration and a customer behavior analysis system for formulating a marketing strategy.

### Specific Use Case

For example, when a resident inputs “Tell me the garbage collection days this week” in a natural language on a chatbot screen of a smartphone, the user interface unit receives the question, the authentication and authorization unit acquires a resident ID and residential area information, and the information collection and integration unit automatically extracts garbage collection day information of the corresponding area from a garbage collection schedule management system, a regional portal site, an electronic bulletin board, an FAQ database, and the like. The search unit vectorizes the question sentence and the text of each piece of information by a text embedding technology, calculates a semantic similarity, and selects information such as “Burnable garbage is collected every Tuesday and Friday, and non-burnable garbage is collected on the second and fourth Wednesdays” as the most highly relevant information. The generative AI cooperation unit generates a prompt to the generative AI based on the selected information and the question sentence, and causes the generative AI to read a prompt sentence such as “Question from resident: ‘Tell me the garbage collection days this week’, Reference information: ‘Burnable garbage is collected every Tuesday and Friday, and non-burnable garbage is collected on the second and fourth Wednesdays’, Based on this information, please answer clearly and concisely for the resident.” The generative AI generates a specific answer sentence such as “This week, Tuesday and Friday are burnable garbage days. Non-burnable garbage is collected on the second and fourth Wednesdays.”, and the output unit returns it to the chatbot screen. Furthermore, a link to a garbage separation guide or a collection calendar, and guidance to a related FAQ are automatically added as necessary. Specifically, the user interface unit receives an HTTP request transmitted from an application on the smartphone. The authentication and authorization unit analyzes a session token included in a request header to specify an identifier of the resident. The information collection and integration unit acquires a residential area code linked to the specified identifier from a database. The search unit inputs the input natural language character string “Tell me the garbage collection days this week” to a text encoder. The text encoder converts the input character string into a question vector composed of, for example, a floating-point array having 512 dimensions. The search unit applies the residential area code as a filter condition to narrow down an information group of the corresponding area. The search unit executes an inner product operation between each text vector of the narrowed-down information group and the question vector. The search unit generates an array of similarity scores for each piece of information as an output. For example, the search unit calculates an extremely high similarity score of 0.95 for text data “Burnable garbage is collected every Tuesday and Friday, and non-burnable garbage is collected on the second and fourth Wednesdays”. The search unit extracts this text data as an optimal context. The generative AI cooperation unit combines the extracted optimal context and the original question sentence to construct a prompt character string. The generative AI cooperation unit inputs the constructed prompt character string to a large language model. The large language model analyzes the context of the input prompt and sequentially calculates a probability distribution of a word to be output next. The large language model generates a natural Japanese text character string “This week, Tuesday and Friday are burnable garbage days, and non-burnable garbage is collected on the second and fourth Wednesdays” as an output. The output unit stores the generated text character string in a response payload in a JSON format. The output unit adds a URL of a related garbage separation guide to the payload. The output unit transmits the response payload to the smartphone of the user to render it on the screen. The system completely saves the resident the trouble of navigating a complex website of a local government. The system dramatically improves the convenience of the resident by instantly providing necessary information. The system brings about a technical effect of significantly reducing the number of routine inquiries received by a call center of a local government and dramatically lowering the operation cost of the administration. The system is optimal for use cases such as a concierge service for residents in a smart city.

For example, when an administrative staff member inputs “Search for the latest disaster prevention manual” on a dedicated screen of a personal computer, the authentication and authorization unit acquires a staff ID and affiliated department information, and the information collection and integration unit extracts the latest disaster prevention manual information from a disaster prevention information portal, a business manual database, an electronic bulletin board, past disaster response records, and the like. The search unit vectorizes the question sentence and the text of each piece of information by a text embedding technology, calculates a semantic similarity, and selects information such as “The disaster prevention manual revised in April 2024 includes evacuation guidance procedures during a disaster, an emergency contact network, shelter opening procedures, and material distribution methods during a disaster”. The generative AI cooperation unit causes the generative AI to read a prompt sentence such as “Question from administrative staff: ‘Search for the latest disaster prevention manual’, Reference information: ‘The disaster prevention manual revised in April 2024 includes evacuation guidance procedures during a disaster, an emergency contact network, shelter opening procedures, and material distribution methods during a disaster.’, Based on this information, please summarize the main points and answer for the administrative staff.” The generative AI generates a summary answer such as “In the latest disaster prevention manual, evacuation guidance procedures when a disaster occurs, operation of an emergency contact network, rapid opening procedures for shelters, and a flow of material distribution are clearly stated. For details, please refer to the manual PDF.”, and the output unit returns it to the staff terminal, and automatically adds a link to the manual PDF and related materials. Specifically, the authentication and authorization unit intercepts a request transmitted from the terminal of the administrative staff member, inquires of a directory service of the staff member, and acquires attribute data of an affiliated department and a job title level. The information collection and integration unit dynamically determines a range of an accessible internal database based on the acquired attribute data. The search unit inputs the input character string “Search for the latest disaster prevention manual” to a text encoder, and generates a high-dimensional question vector. The search unit calculates a cosine similarity between a vector of each document in the internal database and the question vector. The search unit calculates a freshness score using a last update date and time of the document as a parameter in addition to the similarity score. The search unit calculates a comprehensive ranking score by weighting and adding the similarity score and the freshness score. The search unit extracts text data of the disaster prevention manual revised in April 2024 having the highest comprehensive ranking score as an output. The generative AI cooperation unit combines the extracted long manual text and the question sentence to construct a prompt character string including a summarization instruction. The generative AI cooperation unit inputs the prompt character string to a large language model. The large language model specifies an important context in the long text using a self-attention mechanism. The large language model generates a concise summary text extracting the main points of the manual as an output. For example, the large language model outputs a text “Evacuation guidance procedures when a disaster occurs, operation of an emergency contact network, rapid opening procedures for shelters, and a flow of material distribution are clearly stated”. The output unit generates a direct download link to the original manual PDF file together with the generated summary text. The output unit transmits a rendering instruction for displaying these data on the terminal screen of the staff member. The system dramatically shortens a search time for finding target information from a huge amount of internal documents. The system reduces a cognitive load of reading and understanding a long manual, and supports rapid decision-making in an emergency. The system exhibits a technical effect of achieving both strict access control based on authority and advanced information extraction, and providing a secure and efficient business environment. The system is widely applicable to use cases such as a contract search system in a legal department of a company and a response history search system in a customer support department.

For example, when a foreign resident inputs “Where is the nearest evacuation shelter?” in English on a multilingual touch panel terminal, the authentication and authorization unit acquires a language setting and position information, and the information collection and integration unit extracts nearest evacuation shelter information from an evacuation shelter management system, a regional portal, a map database, opening status data from an IoT sensor, and the like. The search unit vectorizes the question sentence and the text of each piece of information by a text embedding technology, calculates a semantic similarity, and selects information such as “The nearest evacuation shelter is XX Elementary School, the address is 1-2-3 XX Town, XX Ward, currently open, wheelchair accessible, and pets allowed”. The generative AI cooperation unit causes the generative AI to read a prompt sentence such as “Question from foreign resident: ‘Where is the nearest evacuation shelter?’, Reference information: ‘The nearest evacuation shelter is XX Elementary School, the address is 1-2-3 XX Town, XX Ward, currently open, wheelchair accessible, and pets allowed’, Based on this information, please answer clearly in English.” The generative AI generates an English answer such as “The nearest evacuation shelter is XX Elementary School, located at 1-2-3 XX Town, XX Ward. It is currently open, wheelchair accessible, and allows pets.”, and the output unit returns it to the touch panel terminal, and also adds a map display and a link to a multilingual evacuation shelter guidance page. Specifically, the authentication and authorization unit acquires a current language setting flag from an operating system of the touch panel terminal. The information collection and integration unit acquires coordinate data of latitude and longitude of a current location from a GPS module built in the terminal. The search unit inputs the input English question sentence to a multilingual text encoder. The multilingual text encoder maps the question sentence to a common latent space independent of language, and outputs a language-independent question vector. The search unit executes a spatial search algorithm, and extracts a list of evacuation shelters existing within a predetermined radius from the coordinate data of the current location. The search unit performs a similarity calculation between the extracted metadata of the evacuation shelters and the question vector. The search unit evaluates an opening status flag of the evacuation shelter acquired in real time from the IoT sensor. The search unit selects information of an evacuation shelter that is open and has the shortest straight-line distance from the current location as an optimal solution. The generative AI cooperation unit combines the selected Japanese evacuation shelter information and the English question sentence to construct a prompt character string instructing an answer in English. The generative AI cooperation unit inputs the prompt character string to a large language model. The large language model understands the input Japanese context and generates an answer sentence using a vocabulary of English which is a designated target language. The large language model generates an accurate English text character string as an output. The output unit generates a URL of a map image indicating a route from the current location to the evacuation shelter together with the generated English text. The output unit displays these pieces of information on a display of the touch panel terminal. The system provides real-time crisis management information across language barriers. The system realizes optimal guidance suited to a physical situation of the user by highly integrating spatial information and semantic search. The system brings about an extremely important technical effect directly linked to ensuring the safety of foreign tourists and residents during a disaster. The system exhibits tremendous power in use cases such as a guidance kiosk terminal at an international airport and a multilingual navigation system in a tourist destination.

For example, when a resident asks “I want to know the schedule of local events”, the information collection and integration unit extracts corresponding event information from a local event management system, a shopping street portal, SNS cooperation data, past holding record data, and the like, and the search unit selects information such as “The summer festival will be held at XX Park from 18:00 on August 5, participation fee is free, held rain or shine, many food stalls will be open”. The generative AI cooperation unit causes the generative AI to read a prompt sentence such as “Question from resident: ‘I want to know the schedule of local events’, Reference information: ‘The summer festival will be held at XX Park from 18:00 on August 5, participation fee is free, held rain or shine, many food stalls will be open’, Based on this information, please guide the resident clearly.” The generative AI generates an answer such as “The summer festival will be held at XX Park from 18:00 on August 5. The participation fee is free, and it will be held even in the rain. Many food stalls are also scheduled to be open.”, and the output unit returns it to the chatbot screen, and automatically adds a link to an event official website, a map, and an SNS account. Specifically, upon receiving the question sentence from the user, the information collection and integration unit activates a named entity extraction model to analyze the intent of the question. The named entity extraction model extracts entities of a local event and a holding schedule from the input text. The search unit executes a search on an event management database using the extracted entities as query parameters. The search unit acquires a current date and time, and applies a temporal filtering process for excluding past events. The search unit inputs text data of the filtered event information to a text encoder to vectorize it. The search unit extracts information of the summer festival having the highest relevance by similarity calculation with the question vector. The generative AI cooperation unit combines the extracted detailed data of the event and the question sentence to construct a prompt character string. The generative AI cooperation unit inputs the prompt character string to a large language model. The large language model analyzes a context in which the input structured data and unstructured data are mixed. The large language model generates a guidance text reconstructed into a format that the user can naturally read as an output. For example, the large language model outputs a text “The summer festival will be held at XX Park from 18:00 on August 5, the participation fee is free, and it will be held even in the rain”. The output unit dynamically generates a hyperlink to an official website of the event and a data file for adding a schedule to a calendar application of a smartphone in addition to the generated text data. The output unit returns a response in a rich text format integrating these elements to the chatbot screen. The system centrally aggregates distributed event information, and instantly structures and presents it in response to a user request. The system completely eliminates the trouble of the user patrolling a plurality of websites to collect information. The system exhibits a technical effect of promoting regional revitalization and improving an event participation rate of residents. The system is widely applicable to use cases such as a campaign guidance system of a commercial facility and a campus information providing system of a university.

As described above, the system of the present invention realizes an environment in which residents and administrative staff can centrally and rapidly acquire information necessary for city life and administrative operation in a natural language, and significantly improves the quality and efficiency of city services through advanced semantic understanding and information integration, personalization, multilingual support, and related information provision by the generative AI. Specifically, the system operates on a distributed computing environment in which a plurality of arithmetic processing nodes are coupled via a network. The system adopts a microservice architecture that deploys each processing module as an independent container. The system utilizes a parallel arithmetic cluster using an image processing semiconductor in order to speed up inference processing of a large language model. The system executes a series of complex arithmetic processing of high-dimensional vector conversion by a text encoder, high-speed similarity search using a vector database, and autoregressive text generation by a large language model with a latency in milliseconds for an input natural language query. The system solves fundamental technical problems of search omission due to orthographical variants and non-understanding of context, which have been held by a conventional search system depending on keyword matching. The system provides personalized information optimized for each user by a dynamic prompt generation process based on user attributes and past action histories. The system generates a multilingual answer in real time from a database constructed in a single language by applying a cross-lingual model. By integrating these advanced information processing mechanisms, the system completely replaces a conventional mental process in which a human manually searches, summarizes, and translates information. The system dramatically improves the processing efficiency and data management capability of computer technology itself. The system semantically combines a huge amount of data scattered in a city, and provides an intuitive and seamless information access interface to residents and administrative staff. The system brings about an extremely excellent technical effect of promoting digital transformation of city operation and dramatically improving the quality and operation efficiency of administrative services. The system functions as a platform playing a core role in use cases such as a next-generation smart city infrastructure system and an integrated knowledge management system for large enterprises.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

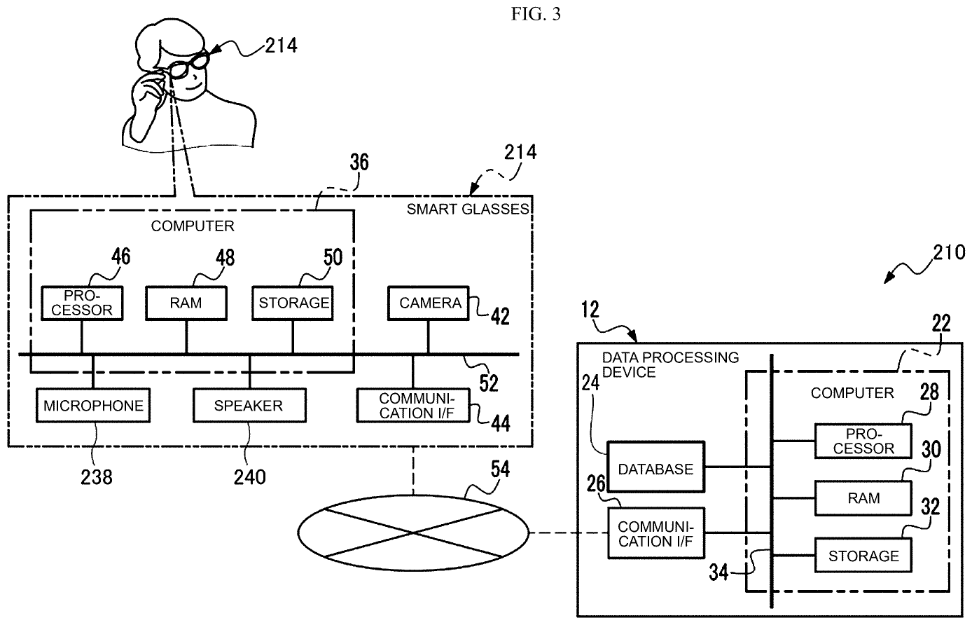

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

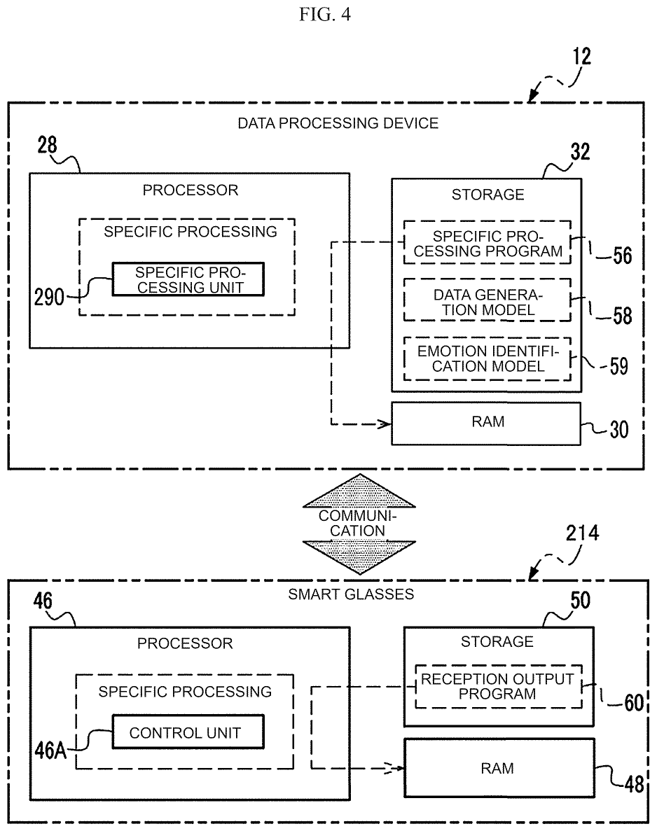

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

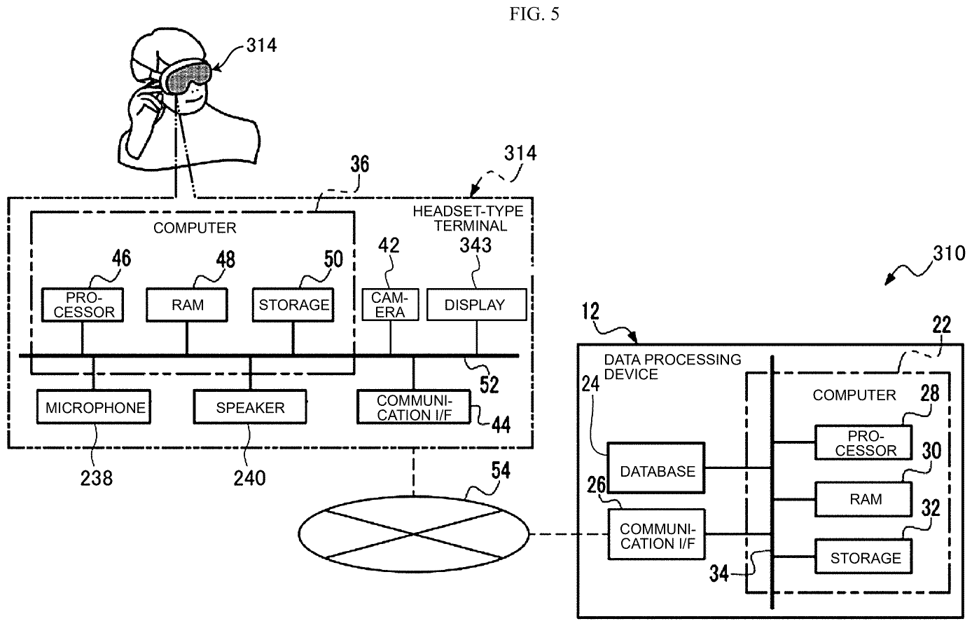

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

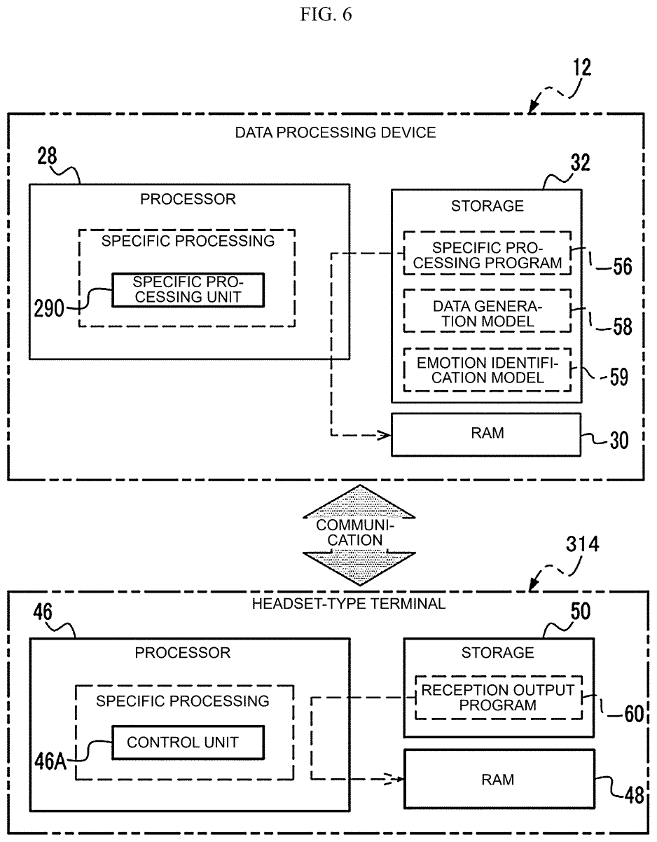

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

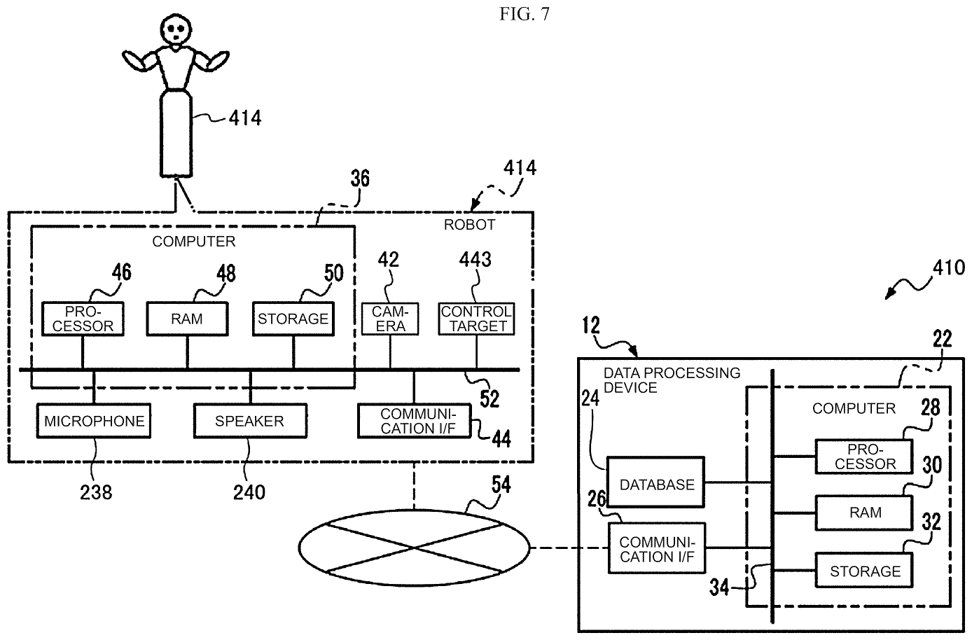

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

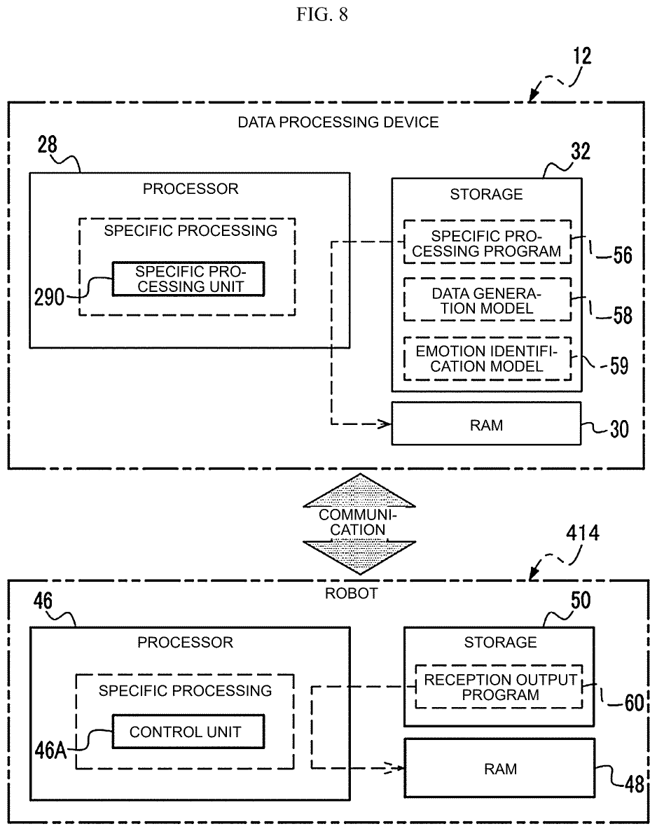

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

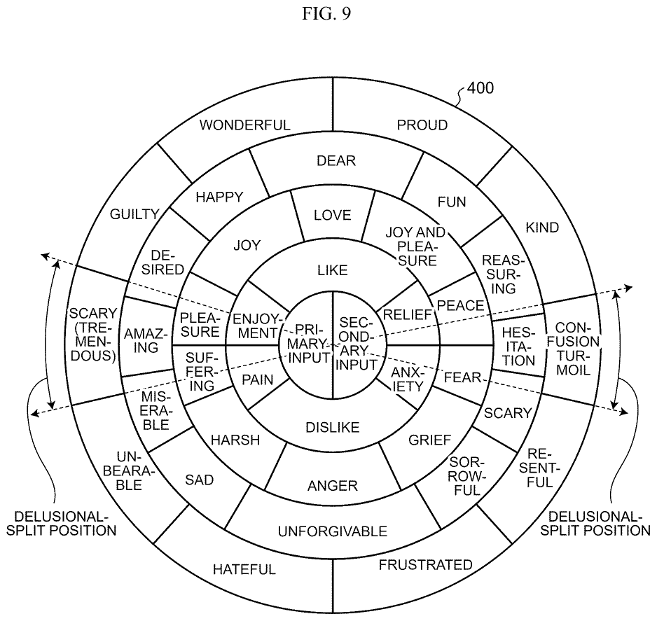

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

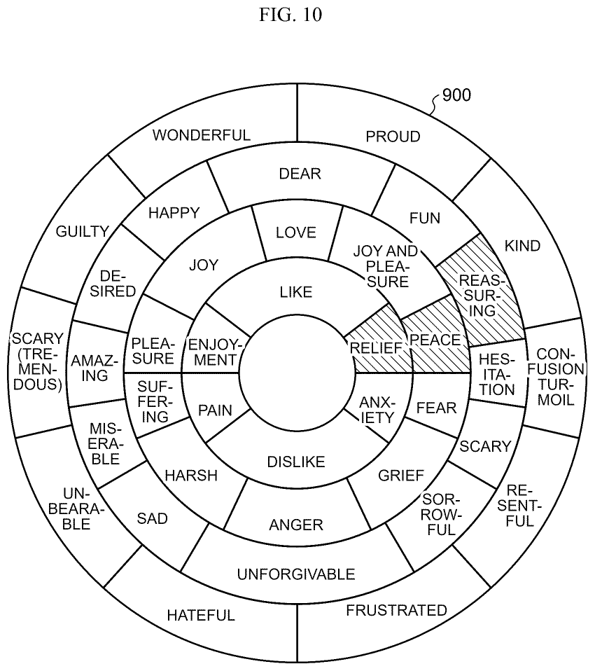

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A smart city information providing system capable of centrally searching and acquiring a wide variety of information necessary for city life and administrative operation by residents and administrative staff in a city, the system comprising: a user interface unit; an information collection and integration unit; a search unit; a generative AI cooperation unit; an output unit; a self-maintenance unit; a security management unit; and a log management unit, wherein the user interface unit receives a question input in a natural language from a resident or an administrative staff member; the information collection and integration unit automatically collects information from a plurality of information management systems, websites, databases, electronic bulletin boards, FAQs, business manuals, and the like in the city, such as garbage collection, disaster prevention, child-rearing support, transportation, and administrative procedures, to construct an integrated database; the search unit extracts only accessible information based on authority information and attribute information of a user, semantically compares the extracted information and a question sentence using a text embedding technology, and selects information with the highest relevance; the generative AI cooperation unit generates a prompt to a generative AI with the selected information and the question sentence as inputs, and generates an answer sentence in a natural language; the output unit presents the answer sentence by the generative AI to a user terminal; the self-maintenance unit automatically detects new information or update information using an API, an RSS feed, a file monitoring function, or the like of each information management system or website, and keeps an information database in an always latest state; the security management unit controls information access according to an authority of the resident or the staff member; and the log management unit records all question/answer histories, information access histories, and information update histories, wherein at least a part of processing of the search unit and the generative AI cooperation unit is executed by the generative AI.

### Supplementary Note 2

The system according to Supplementary Note 1, wherein the self-maintenance unit includes processing of automatically detecting generation of new information or an update of existing information in various information management systems and websites in the city, such as garbage collection days, disaster prevention information, traffic operation information, administrative procedure guidance, and child-rearing support systems, extracting content of corresponding information as a semantic feature amount by a text embedding technology, and automatically adding or updating the content in the information database, thereby preventing operation from becoming dependent on individual skills and enabling provision of always latest and accurate city information to the residents and the administrative staff.

### Supplementary Note 3

The system according to Supplementary Note 1, wherein the generative AI cooperation unit includes processing of analyzing a past question history, an access tendency, and attribute information (for example, residential area, age group, language setting, occupation, etc.) of the user by machine learning to perform personalized information recommendation for each user, and generating an answer sentence optimized in consideration of the attribute information and a usage status of the user when generating an answer by the generative AI, thereby realizing most appropriate and rapid city information access for each resident and administrative staff member.

What is claimed is:

1. A system comprising:
circuitry configured to:
receive, via a communication interface coupled to a packet-switched network, query data comprising natural language text from a terminal device, and store the query data in a storage device;
retrieve a user access permission record associated with a user identifier from an access control data structure in the storage device, apply an access filter to a vector database index to exclude document records outside the user access permission record, and generate a query embedding vector from the query data using a text embedding model;
compute cosine similarity scores between the query embedding vector and document embedding vectors indexed in the filtered vector database, and select document records having cosine similarity scores exceeding a retrieval threshold parameter;
apply a generative neural network model to the query data and the selected document records to generate a response text record, the response text record comprising a natural language answer and source reference identifiers corresponding to the selected document records; and
transmit the response text record to the terminal device via the communication interface.

2. The system according to claim 1, wherein the circuitry is configured to
detect generation of new information records or updates to existing information records in external information management systems via API polling, extract text content from the detected records, apply the text embedding model to generate updated document embedding vectors, and update the vector database index by inserting or replacing document embedding vectors associated with the corresponding document identifiers.

3. The system according to claim 2, wherein the circuitry is configured to
apply a change detection algorithm by computing a cosine similarity score between a new document embedding vector and the existing document embedding vector for the same document identifier, and trigger an index update when the similarity score falls below a change threshold parameter, thereby ensuring the vector database reflects the latest content of each information record.

4. The system according to claim 1, wherein the circuitry is configured to
apply a multi-stage retrieval process by first selecting candidate document records using approximate nearest neighbor indexing, and then reranking the selected candidate document records using a cross-encoder relevance model that jointly encodes the query data and each candidate document record to compute a refined relevance score.

5. The system according to claim 4, wherein the circuitry is configured to
apply a personalization weight to each reranked document record by retrieving a user access history record and a query pattern embedding vector associated with the user identifier from the storage device, computing a preference affinity score between the query pattern embedding vector and each candidate document embedding vector, and adjusting the relevance score of each candidate document record by the preference affinity score.

6. The system according to claim 5, wherein the circuitry is configured to
update the user access history record by appending the query data, the query embedding vector, and the identifiers of the selected document records as a query session entry, and update the query pattern embedding vector by computing a weighted average of the current query pattern embedding vector and the new query embedding vector.

7. The system according to claim 1, wherein the circuitry is configured to
apply an ambiguity classification model to the query embedding vector to generate an ambiguity score, and generate a clarification prompt comprising targeted clarification questions when the ambiguity score exceeds an ambiguity threshold parameter, and transmit the clarification prompt to the terminal device prior to executing the retrieval pipeline.

8. The system according to claim 1, wherein the circuitry is configured to
receive audio waveform data from the terminal device via the communication interface, apply a speech recognition model to convert the audio waveform data into query text, and incorporate the query text into the query embedding vector generation pipeline.

9. The system according to claim 8, wherein the circuitry is configured to
detect a language identifier from the audio waveform data or query text, apply a machine translation model to translate the query text into a target language when the detected language identifier differs from a system language parameter, and apply the text embedding model to the translated query text.

10. The system according to claim 1, wherein the circuitry is configured to
distribute incoming query requests from terminal devices to a plurality of inference service nodes via a load balancer, and execute the generative neural network model inference on a parallel computing cluster using graphics processing units to minimize response latency under concurrent request loads.

11. The system according to claim 1, wherein the circuitry is configured to
generate an expanded query by applying the generative neural network model to the query data to produce a set of semantically related query variant text strings, compute embedding vectors for each query variant, and aggregate cosine similarity scores across the query embedding vector and all query variant embedding vectors when selecting document records from the vector database.

12. The system according to claim 1, wherein the circuitry is configured to
store the query data, query embedding vector, selected document records, and response text record as a query session record in the storage device, and generate a query frequency report by aggregating query session records over a time window to identify high-frequency query pattern clusters for transmission to terminal devices associated with administrative user identifiers.

13. The system according to claim 1, wherein the circuitry is configured to
enforce a role-based access control policy by retrieving role-specific access permission parameters associated with the user identifier, computing a permission intersection between the role-specific access permission parameters and document-level access restriction parameters stored in the vector database index, and restricting the retrieval set to document records within the permission intersection.

14. The system according to claim 13, wherein the circuitry is configured to
generate an access denial notification when a query session requests document records outside the user access permission record, log the access denial event with a timestamp, user identifier, and requested document category in an audit log data structure in the storage device, and transmit the access denial notification to the terminal device.

15. The system according to claim 1, wherein the circuitry is configured to
apply a response quality evaluation model to the response text record by computing a factual grounding score measuring overlap between claims in the response text record and content in the selected document records, and append a confidence indicator parameter to the response text record when the factual grounding score exceeds a confidence threshold.

16. The system according to claim 1, wherein the circuitry is configured to
update the generative neural network model by generating training pairs from historical query session records comprising query data and corresponding validated response text records, and fine-tune the generative neural network model on the training pairs to improve response quality scores for domain-specific query patterns.

17. The system according to claim 1, wherein the vector database stores document embedding vectors derived from information records distributed across a plurality of heterogeneous information management systems, and the access control data structure maps user identifiers to permitted information management system categories and document classification labels.

18. A system comprising:
circuitry configured to:
receive, via a communication interface coupled to a packet-switched network, natural language query data and a user identifier from a terminal device;
retrieve a user access permission record associated with the user identifier, apply an access filter to a vector database index, generate a query embedding vector using a text embedding model, and select document records by cosine similarity scoring within the filtered index;
rerank the selected document records using a cross-encoder relevance model adjusted by a personalization preference affinity score derived from a stored user query pattern embedding vector;
apply a generative neural network model to the query data and the reranked document records to generate a response text record; and
transmit the response text record to the terminal device via the communication interface, and update the vector database index by inserting updated document embedding vectors when content changes are detected in external information management systems.

19. The system according to claim 18, wherein the circuitry is configured to
receive audio waveform data from the terminal device, apply a speech recognition model to generate query text, detect a language identifier, apply a machine translation model when the detected language identifier differs from a system language parameter, and generate an expanded query by applying the generative neural network model to produce semantically related query variant text strings for aggregated similarity scoring.

20. A method comprising:
receiving, via a communication interface coupled to a packet-switched network, query data comprising natural language text from a terminal device, and storing the query data in a storage device;
retrieving a user access permission record associated with a user identifier from an access control data structure in the storage device, applying an access filter to a vector database index to exclude document records outside the user access permission record, and generating a query embedding vector from the query data using a text embedding model;
computing cosine similarity scores between the query embedding vector and document embedding vectors indexed in the filtered vector database, and selecting document records having cosine similarity scores exceeding a retrieval threshold parameter;
applying a generative neural network model to the query data and the selected document records to generate a response text record; and
transmitting the response text record to the terminal device via the communication interface.
